(19) United States
(12) Patent Application Publication
(10) Pub. No.: US 2023/0237361 A1
(43) Pub. Date: Jul. 27, 2023

(54) SYSTEM AND METHOD FOR GENERATING QUANTUM CIRCUITS

(71) Applicant: Cambridge Quantum Computing Limited, London (GB)

(72) Inventors: Alexander COWTAN, Glasgow (GB); Ross William DUNCAN, Cambridge (GB); William Victor SIMMONS, Cambridge (GB)

(73) Assignee: Cambridge Quantum Computing Limited, London (GB)

(21) Appl. No.: 17/919,038

(22) PCT Filed: Apr. 12, 2021
(86) PCT No.: PCT/GB2021/050887

§ 371 Date: Oct. 14, 2022

Related U.S. Application Data
(63) Continuation-in-part of application No. 16/848,530, filed on Apr. 14, 2020, now Pat. No. 11,144,689.

(51) Int. Cl. G06N 10/20; G06N 10/60

(52) U.S. Cl. CPC G06N 10/20; G06N 10/60

(57) ABSTRACT

The is provided a computer-implemented method for generating a quantum circuit from a Unitary Coupled Cluster (UCC) Ansatz, wherein the Ansatz represents an excitation of a reference state by a parameterised operator including excitation operators, and wherein the Ansatz includes multi-qubit Pauli operators that are determined from each excitation operator. The method comprises: partitioning the Pauli operators into mutually commuting sets and sequencing the Pauli operators by set; generating Pauli gadgets from the Pauli operators by Trotterization, wherein the Pauli gadgets have a same sequencing by set as the Pauli operators; diagonalising each set of Pauli gadgets to convert the Pauli gadgets into phase gadgets; and transforming the phase gadgets into one- and two-qubit native gates to generate the quantum circuit. Moreover, there is also provided a system that is configured to implement the method.

### TECHNICAL FIELD

The present disclosure relates to methods for (namely methods of) generating quantum circuits. Moreover, the present disclosure relates to systems for generating quantum circuits. The quantum circuits are susceptible to being used for implementing neural networks, simulations of real physical systems, simulations of quantum chemistry systems, control systems, data processing systems for processing acquired sensor signals, and so forth. Furthermore, the present disclosure relates to software products that are executable on computing hardware for implementing aforesaid methods using quantum circuits.

### BACKGROUND

Conventional contemporary computers employ binary digital silicon circuits whose circuit features are approaching a size where quantum effects begin to occur. Advanced quantum computers have been devised that specifically use quantum phenomena to achieve enhanced computational power, but are prone to computational errors because the quantum phenomena are very sensitive to environmental conditions. Certain configurations of advanced quantum computers need to be cryogenically cooled to reduce a magnitude of these computational errors. However, despite such technical challenges, quantum computers have been used to solve various types of computational tasks.

When seeking to solve a given computational task on a quantum computer, the computational task is translated to a configuration of a quantum circuit, and the quantum circuit is then implemented in practice by configuring an arrangement of quantum gates. The computational task can be a neural network task or a chemical simulation task, but is not limited thereto.

Beneficially, the aforesaid translation is achieved by using a Variational Quantum Eigensolver (VQE) that is a hybrid quantum-classical algorithm for estimating ground state energies of quantum systems, for example molecules when performing chemical simulations, on Noisy Intermediate Scale Quantum (NISQ) devices [31, 37, 34]. The VQE employs a variational principle to approximate a ground state of a given Hamiltonian, wherein the ground state is an eigenstate, using a subroutine performed on a quantum computer; the subroutine is nested inside a larger optimization routine performed on a classical computer. In particular, the VQE utilises a parameterised quantum circuit as an Ansatz, namely a trial solution; a Unitary Coupled Cluster (UCC) Ansatz [35] is thought to be well-suited for determining the parameterised quantum circuit.

The VQE algorithm typically involves preparing an initial quantum state on a quantum computer and generating an Ansatz quantum state by applying a corresponding parameterised quantum circuit to the initial quantum state. An expectation value of a resulting Hamiltonian, namely an energy of a quantum system being simulated, is determined based on quantum properties of the quantum system. Parameters of the parameterised quantum circuit are then updated in accordance with the VQE algorithm to try to reduce an expectation value in an optimization procedure, namely a minimization procedure, to converge towards a ground (reference) state of the quantum system ([101]).

The aforesaid UCC Ansatz is physically motivated by a molecular system and is believed to converge to chemical accuracy more quickly than alternative configurations of quantum circuits. However, a circuit depth of the UCC Ansatz for many existing implementations scales poorly with respect to a size of molecule to be simulated, and hence a time taken to run the aforesaid subroutine can be relatively long. In addition, an error rate of the subroutine scales with the number of entangling gates required. A quantum computer generally supports a fixed number (namely, set) of qubits; for example, the fixed number is 8 or 16 qubits. Quantum computing operations, implemented using quantum gates, may be performed on the set of qubits. These gates are usually provided as one-qubit gates or two-qubit (entangling) gates; the gates are chosen according to a number of inputs to and outputs from the gate, wherein the quantum gates each have a same number of outputs as inputs. The quantum gates determine how the quantum computer manipulates the qubits of the quantum computer; thus, these quantum gates generally represent low-level operations to be performed by hardware, rather than being hardware devices themselves.

Each set of operations that is performed temporally in parallel across the set of qubits is referred to as a slice or layer; in other words, a slice or layer can be considered as representing one step or iteration of processing within a quantum computer. An overall quantum computation is usually made up of a plurality such slices, wherein the plurality of slices are typically mutually different. The number of slices required for the quantum computation is referred to as the depth of the quantum computation, and generally is a measure of a time duration needed to perform the quantum computation ([102]).

The aforesaid UCC Ansatz can be used to generate a specific configuration of one- and two-qubit native quantum gates representing a quantum circuit for implementation on a quantum computer. Such a generation process is often referred to as a compilation, with the UCC Ansatz serving as an input to the compilation, and a quantum circuit comprising the specific configuration of gates as an output from the compilation. Different compilation strategies may result in different configurations of gates for performing a desired computation. A choice of compilation strategy may in turn significantly impact the performance of a resulting algorithm on a quantum computer; for example, the choice of compilation strategy may impact the performance in terms of efficiency and error rate. Accordingly, enhancing a compilation strategy to be used may directly improve a performance of a computation being performed on quantum computer hardware.

In a published patent document US2020394547 (A1), “Hybrid Quantum-Classical Computer System and Method for Performing Function Inversion”, Zapata Computing Inc., there is described a hybrid quantum-classical computing system that uses a Boolean function which maps at least one input bit to at least one output bit, with a seed output value satisfying at least one condition. Moreover, the hybrid quantum-classical computing system uses a set of constraints such that a satisfying assignment of the constraints corresponds to a specific input value being mapped by the Boolean function to the seed output value. Moreover, the hybrid quantum-classical computing system comprises a quantum computing component having a plurality of qubits and a qubit controller that manipulates the plurality of qubits. Furthermore, the hybrid quantum-classical computing system comprises a classical computing component storing machine-readable instructions that, when executed by a classical computer, control the classical computer to cooperate with the quantum computer to:
(i) translate the constraints into interactions between quantum spins;
(ii) form, from the interactions, an Ising Hamiltonian whose ground state encodes a set of states of the specific input value that are consistent with the set of constraints;
(iii) perform, on the quantum computing component, a quantum optimization algorithm to generate an approximation to the ground state of the Ising Hamiltonian; and
(iv) measure the approximation to the ground state of the Ising Hamiltonian, on the quantum computing component, to obtain a plurality of input bits which are a satisfying assignment of the set of constraints.

In a published patent document US2018032894 (A1), “Quantum Operations with Passive Noise Suppression”, Epstein, there is described a method for performing a quantum operation on a logical qubit, comprising a plurality of physical qubits, that is resilient to noise on control signals, on the individual physical qubits, and on coupling strengths between physical qubits. The method comprises:
(i) applying a set of control signals to provide a first Hamiltonian for a system comprising an array of physical qubits, the array of physical qubits including at least the plurality of physical qubits, and a plurality of coupling mechanisms, each coupling mechanism operatively coupling only an associated pair of neighbouring physical qubits within the array, the first Hamiltonian representing, for each coupling mechanism, a coupling strength between zero and a maximum value; and
(ii) performing an adiabatic interpolation of the Hamiltonian of the system from the first Hamiltonian to a second Hamiltonian, the second Hamiltonian representing, for at least one of the plurality of coupling mechanisms, a coupling strength different from that of the first Hamiltonian.

Despite some examples of progress in problem decomposition, known compilation strategies are not sufficiently accurate for many computation tasks that are to be implemented using quantum computers. Improved methods of configuring gates of quantum computers are therefore required.

### SUMMARY

According to a first aspect, there is provided a computer-implemented method for generating a quantum circuit from a Unitary Coupled Cluster (UCC) Ansatz, wherein the Ansatz represents an excitation of a reference state by a parameterised operator including excitation operators, wherein the Ansatz includes multi-qubit Pauli operators that are determined from each excitation operator, and wherein the method comprises:
partitioning the Pauli operators into mutually commuting sets and sequencing the Pauli operators by set;
generating Pauli gadgets from the Pauli operators by Trotterization, wherein the Pauli gadgets have a same sequencing by set as the Pauli operators;
diagonalising each set of Pauli gadgets to convert the Pauli gadgets into phase gadgets; and
transforming the phase gadgets into one- and two-qubit native gates to generate the quantum circuit.

The computer-implemented method is of advantage in that its synergistic combination of partitioning Pauli operators, generating Pauli gadgets by Trotterization, diagonalizing the Pauli gadgets to generate phase gadgets, and finally transforming the phase gadgets to corresponding quantum gates of a quantum circuit results in a particularly efficient and low noise implementation of the quantum circuit.

The computer-implemented method may be utilised to reduce a count and depth of entangling gates of the quantum circuit relative to a naïve synthesis of the quantum circuit from the Pauli operators, which in turn can help to perform computations more quickly and with lower stochastic noise.

Optionally, in the computer-implemented method, the Pauli operators are Pauli strings.

Optionally, the computer-implemented method includes partitioning the Pauli operators into mutually commuting sets of operators to minimise a number of commuting sets required.

Optionally, the computer-implemented method includes partitioning the Pauli operators using a graph colouring algorithm.

Optionally, in the computer-implemented method, each set of Pauli gadgets is diagonalised using a Clifford circuit.

Optionally, in the computer-implemented method, each set of Pauli gadgets is represented as: (i) a Clifford circuit; (ii) a set of phase gadgets; and (iii) an inverse Clifford circuit. More optionally, in the computer-implemented method, the Clifford circuit transforms between an original basis of the Pauli gadgets and a new basis in which the Pauli gadgets are represented by a corresponding set of phase gadgets.

Optionally, in the computer-implemented method, wherein for two qubits i and j and a set S of m mutually commuting Pauli gadgets, wherein σₖₗ is a Pauli letter on qubit k from Pauli gadget l, the qubit i or j is diagonalised by conjugating with at most one entangling gate and two single-qubit Clifford gates on each side of S between qubits i and j, subject to a proviso:

∃A,B∈{X,Y,Z}s.t.∀l∈{1, . . . ,m},σᵢₗ∈{I,A}⇔σⱼₗ∈{I,B}

More optionally, in the computer-implemented method, if the proviso is not satisfied, a diagonalisation of the qubit i or j is performed by:
finding a Pauli string with a lowest weight;
conjugating a corresponding Pauli gadget with a single-qubit Clifford gate and entangling gates; and
commuting the Clifford gate through a rest of the Pauli gadgets until all Clifford gates are outside their adjacent Pauli gadgets.

Optionally, the computer-implemented method includes transforming the phase gadgets into one- and two-qubit native gates to generate the quantum circuit using a phase polynomial formalism.

More optionally, the computer-implemented method includes transforming the phase gadgets by using the phase polynomial formalism, wherein the phase polynomial formalism includes using a GraySynth procedure such as disclosed in [7].

Optionally, the computer-implemented method further comprises:
performing Clifford peephole optimisation by finding patterns of two-qubit Clifford circuits; and
replacing the found patterns of two-qubit Clifford circuits with equivalent circuits having lower counts of entangling gates.

According to a second aspect, there is provided a system for generating a quantum circuit from a Unitary Coupled Cluster (UCC) Ansatz, wherein the Ansatz represents an excitation of a reference state by a parameterised operator including excitation operators, wherein the Ansatz includes multi-qubit Pauli operators that are determined from each excitation operator, and wherein the system comprises:
a partitioning arrangement that is configured to partition the Pauli operators into mutually commuting sets and sequencing the Pauli operators by set;
a generating arrangement that is configured to generate Pauli gadgets from the Pauli operators by Trotterization, wherein the Pauli gadgets have a same sequencing by set as the Pauli operators;
a diagonalizing arrangement that is configured to diagonalise each set of Pauli gadgets to convert the Pauli gadgets into phase gadgets; and
a transforming arrangement that is configured to transform the phase gadgets into one- and two-qubit native gates to generate the quantum circuit.

Optionally, in the system, at least one of the partitioning arrangement, the generating arrangement, the diagonalization arrangement and the transforming arrangement are implemented using a compiler that is executable on at least one data processor.

According to a third aspect, there is provided a computer-implemented method for generating a quantum circuit from a Hamiltonian using a parameterised operator including excitation operators to represent an excitation of a reference state, wherein the method includes determining multi-qubit Pauli operators from each excitation operator, wherein the method comprises:
partitioning the Pauli operators into mutually commuting sets and sequencing the Pauli operators by set;
generating Pauli gadgets from the Pauli operators by Trotterization,

wherein the Pauli gadgets have the same sequencing by set as the Pauli operators;
diagonalising each set of Pauli gadgets to convert the Pauli gadgets into phase gadgets; and
transforming the phase gadgets into one- and two-qubit native gates to generate the quantum circuit.

Optionally, in the computer-implemented method, the multi-qubit Pauli operators are implemented as Pauli strings.

Optionally, in the computer-implemented method, the Hamiltonian corresponds to a Quantum Approximate Optimization Algorithm such as disclosed in [118].

Optionally, in the computer-implemented method, the Ansatz corresponds to at least one of: a molecular structure, a neural network, a natural language processing (NLP) system, an artificial intelligence (AI) system, and a quantum system having a Hamiltonian which is subject to Trotterization

Optionally, the computer-implemented method further comprises using the quantum circuit to perform machine computations. For example, such machine computations may relate (without limitation) to at least one of the following: system optimization, variational inference, signal filtering, genetic data processing to find phenotypes and associated single nucleotide polymorphisms (SNP's), supply-line optimization problems, register allocation problems in computing hardware, job scheduling problems, solid state physics, condensed matter physics, quantum optics, nuclear and/or particle physics, artificial intelligence, neural networks, natural language processing, cryptography and/or quantum systems having a Hamiltonian which is subject to Trotterization, such as for determining molecular structure or quantum evolution (where the Hamiltonian may represent an energy of the quantum system). The quantum circuit may also be used in other areas of machine computation as apparent to the skilled person.

Optionally, the method includes using the method to reduce a count and depth of entangling gates of the quantum circuit relative to a naïve synthesis of the quantum circuit from the Pauli operators.

According to a fourth aspect, there is provided a system for generating a quantum circuit from a Hamiltonian using a parameterised operator including excitation operators to represent an excitation of a reference state, wherein the system is configured to determine multi-qubit Pauli operators from each excitation operator, wherein the system comprises:
a partitioning arrangement that is configured to partition the Pauli operators into mutually commuting sets and sequencing the Pauli operators by set;
a generating arrangement that is configured to generate Pauli gadgets from the Pauli operators by Trotterization, wherein the Pauli gadgets have the same sequencing by set as the Pauli operators;
a diagonalizing arrangement that is configured to diagonalise each set of Pauli gadgets to convert the Pauli gadgets into phase gadgets; and
a transforming arrangement that is configured to transform the phase gadgets into one- and two-qubit native gates to generate the quantum circuit.

Optionally, in the system, the Pauli operators are Pauli strings.

According to a fifth aspect, there is provided a software product that is executable on computing hardware for implementing a method of the first aspect or the third aspect.

It should be appreciated that individual elements of different embodiments described herein may be combined to form other embodiments not specifically set forth above. Various elements, which are described in the context of a single embodiment, may also be provided separately or in any suitable sub-combination.

### BRIEF DESCRIPTION OF THE DIAGRAMS

Various examples and implementations of the disclosure will now be described in detail by way of example only with reference to the following diagrams, wherein:

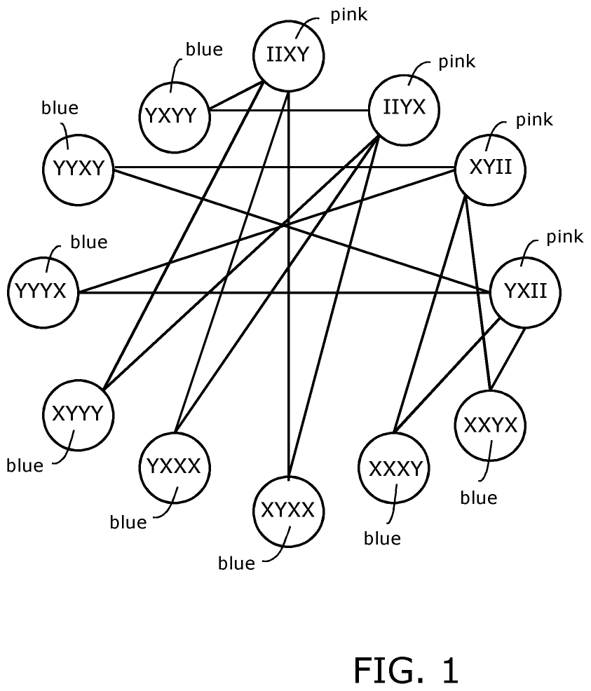

FIG. 1 is a schematic illustration of using graph colouring to partition Pauli terms into sets of mutually commuting Pauli strings, as used in methods, systems and software products according to the present disclosure;

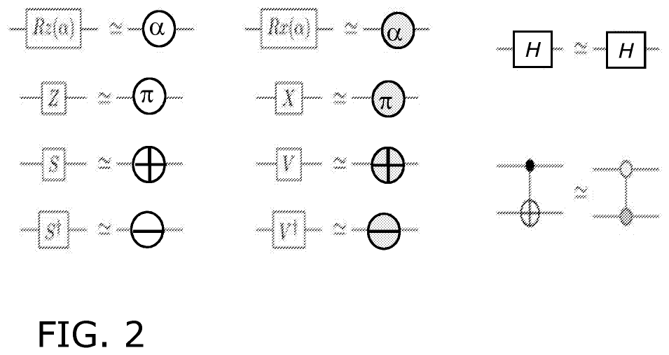

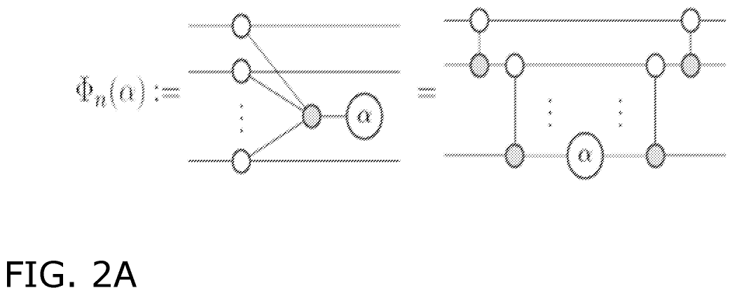

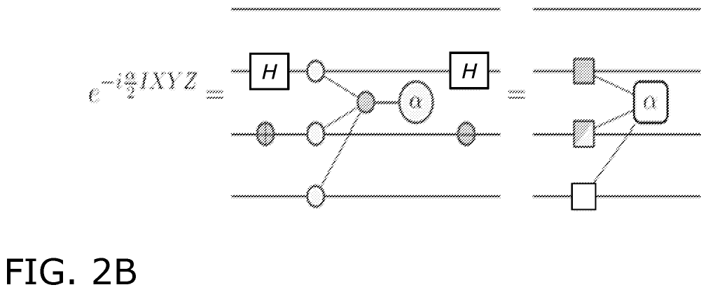

FIG. 2 is an illustration of translating relevant gates between a quantum circuit and corresponding ZX-calculus formalisms, as optionally used in methods according to the present disclosure;

FIG. 2A is an illustration of a representation of a phase gadget ϕn(α) in ZX-calculus notation, as used in methods of the present disclosure;

FIG. 2B is an illustration of a Pauli gadget diagrammatical notation for a Pauli exponential as utilised in methods of the present disclosure;

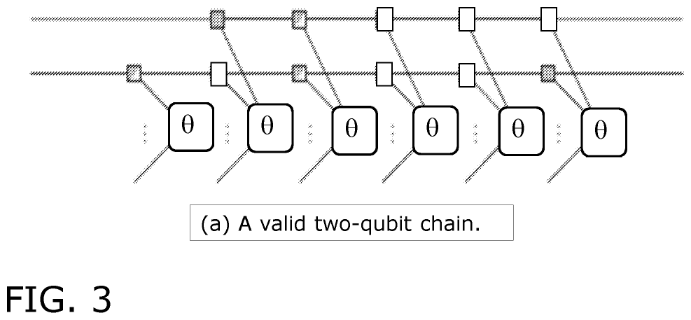

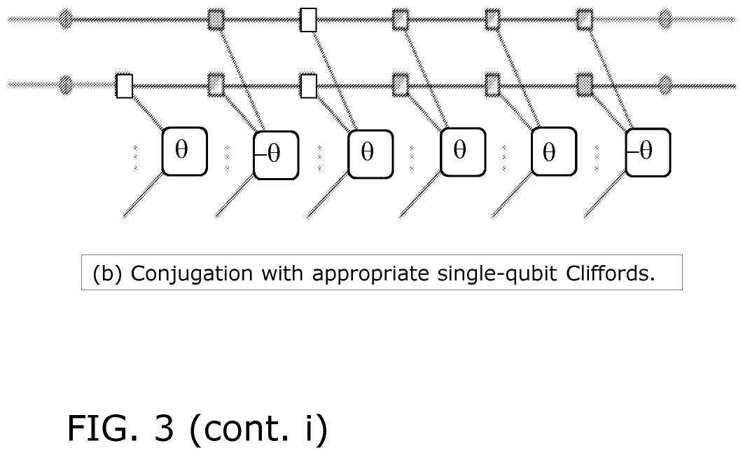

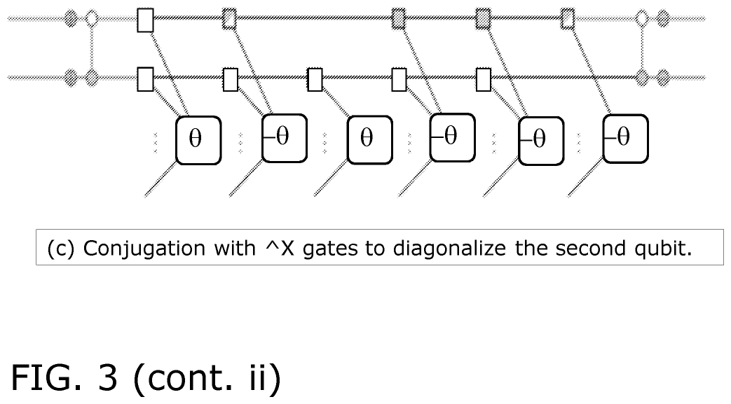

FIG. 3 is an illustration of a method disclosed herein for diagonalising a qubit in accordance with a Theorem 5.1;

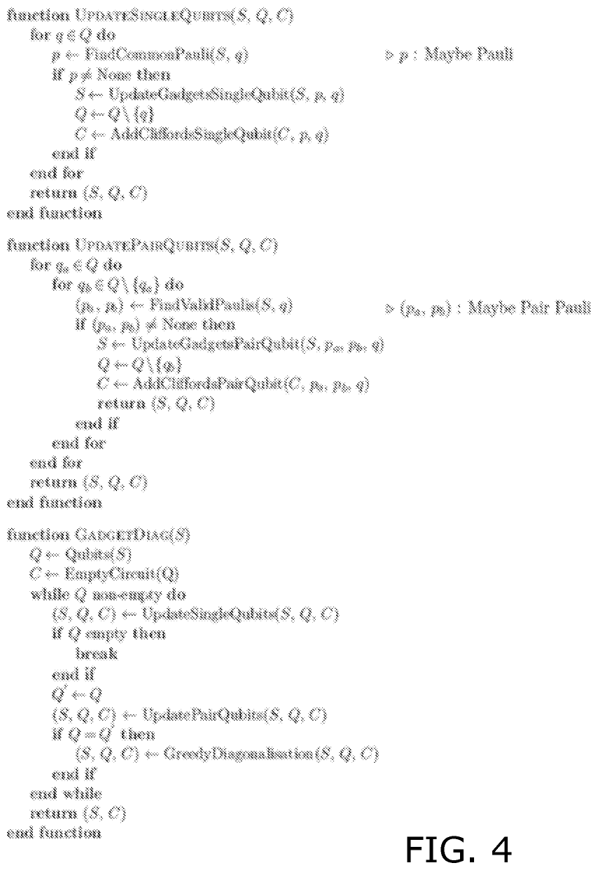

FIG. 4 is an illustration of pseudo-code for a diagonalisation method disclosed herein;

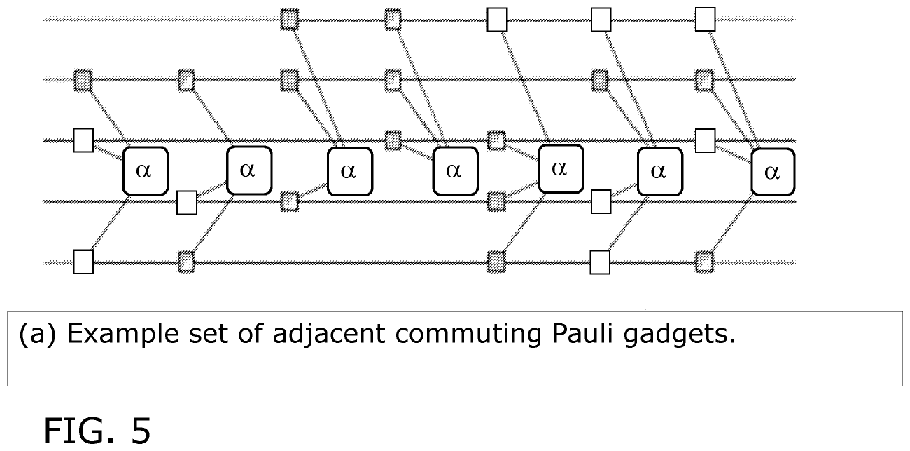

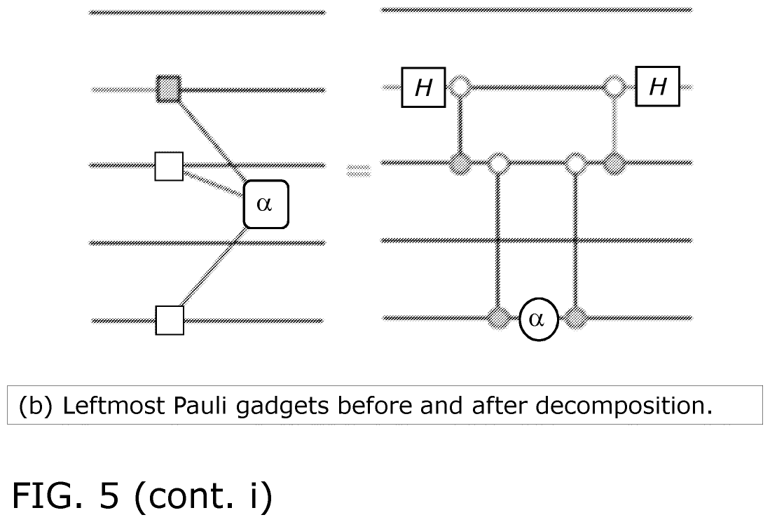

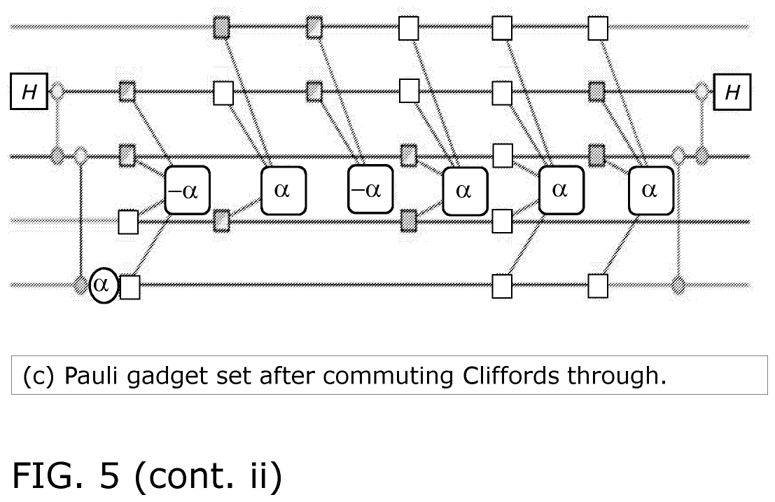

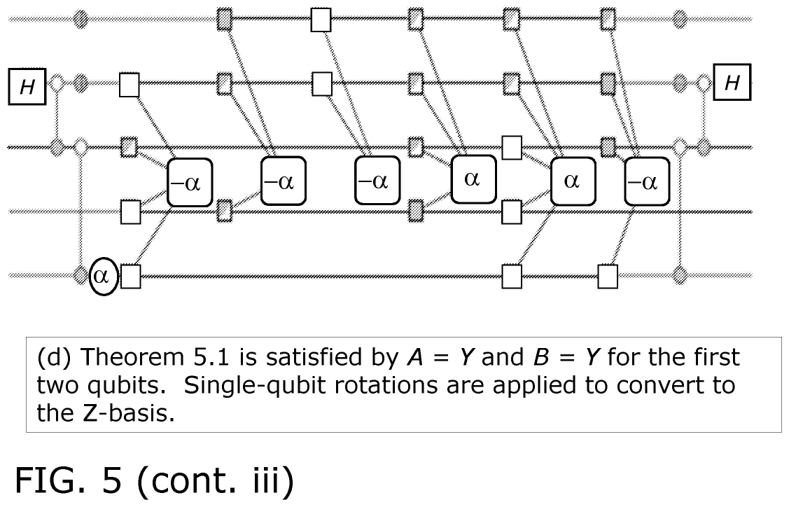

FIG. 5 is an illustration of a diagonalisation method disclosed herein applied to an example set;

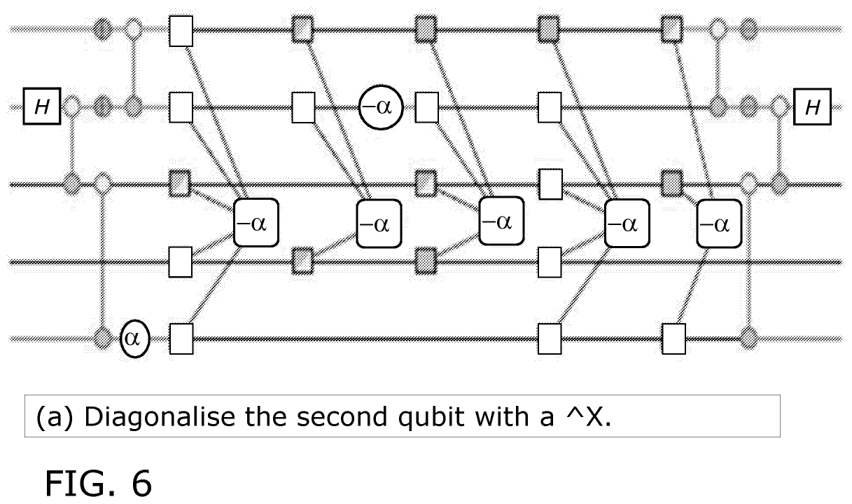

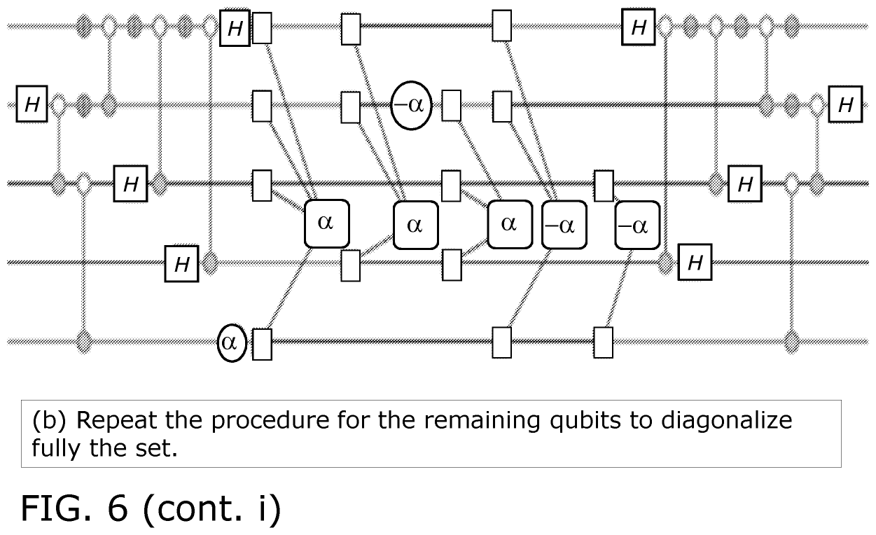

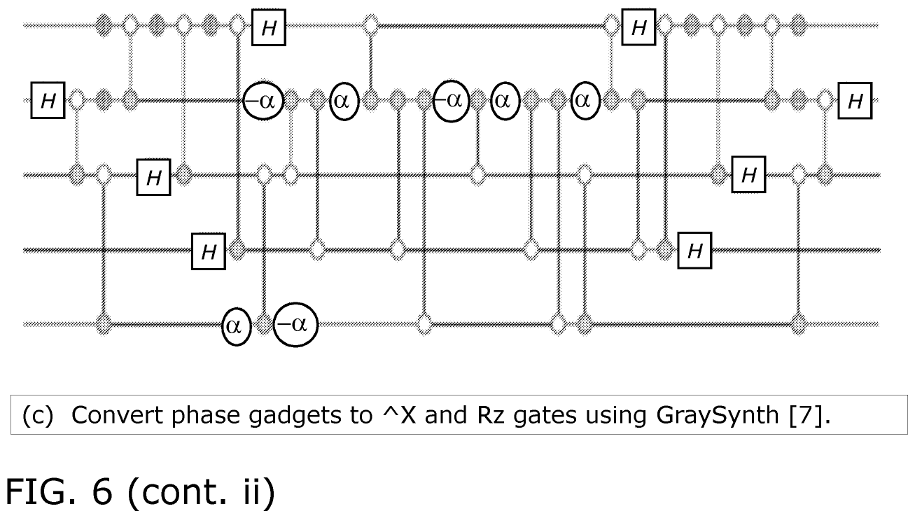

FIG. 6 is a continuation of FIG. 5 to provide an illustration of the method of FIG. 5 applied to an example set having 5 qubits;

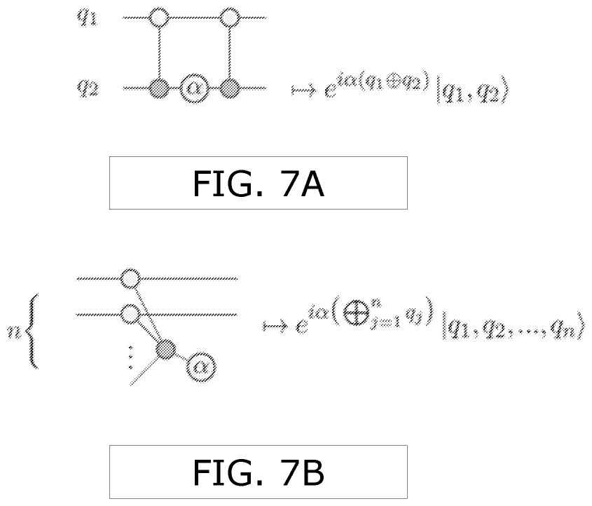

FIGS. 7A and 7B are illustrations of mappings between phase gadgets and quantum circuits using phase polynomials according to a method disclosed herein;

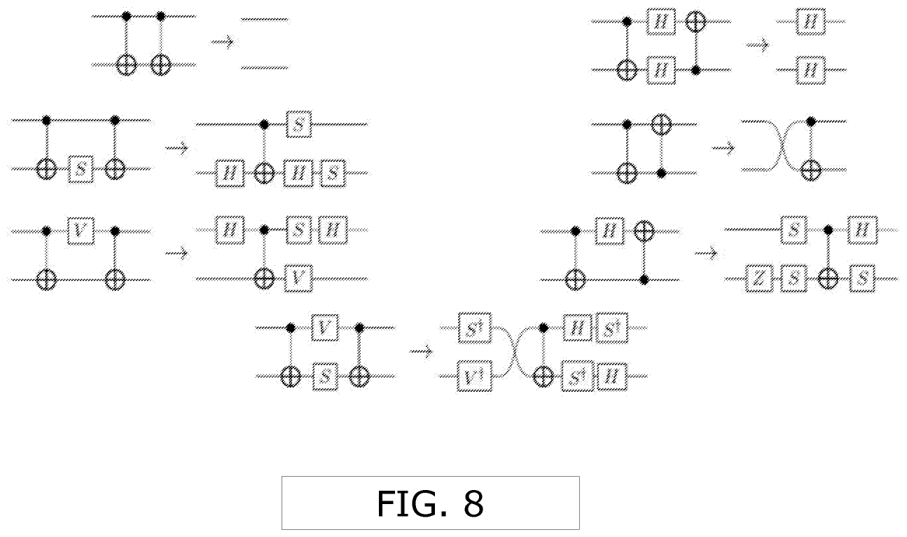

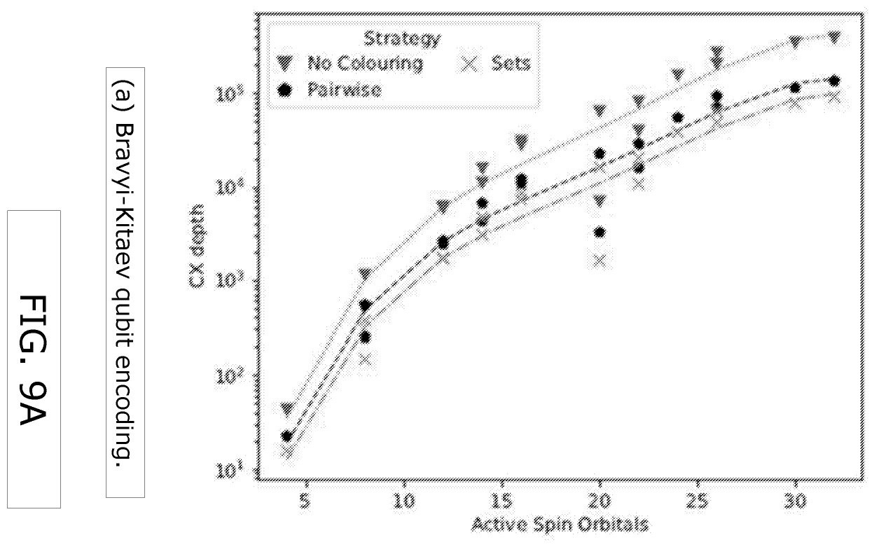

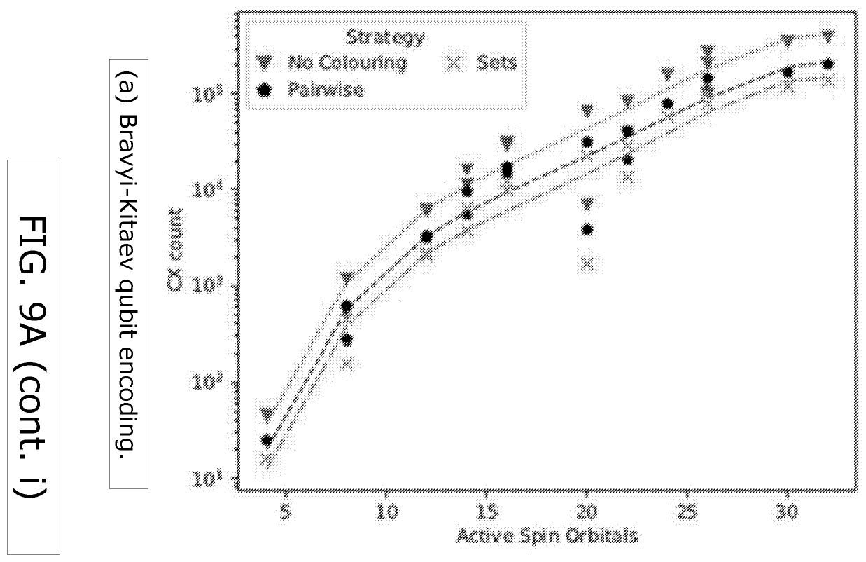

FIG. 8 is an illustration of a Clifford peephole optimisation as disclosed herein, wherein small patterns of two-qubit Clifford circuits are identified and replaced with equivalent circuits with lower ∧X counts;

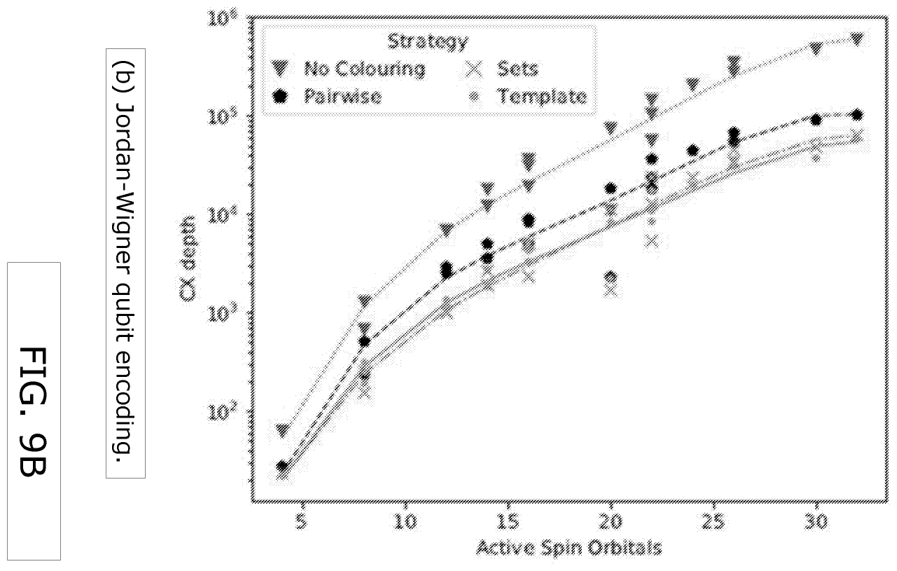

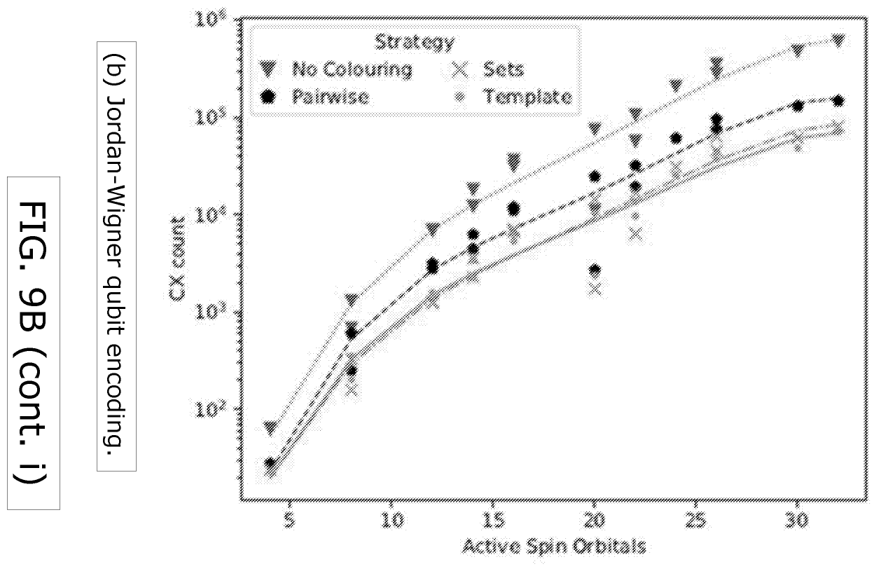

FIGS. 9A, 9B and 9C are illustrations of examples of ∧X metrics obtained using a compilation strategy disclosed herein in comparison to ∧X metrics obtained using other known compilation strategies for use in simulating molecules with varying active spin orbitals and using mutually different qubit encoding methods. FIGS. 9A, 9B and 9C are for BK, JW and P qubit encoding respectively, and show a first plot of CX depth and a second plot of CX count for each encoding;

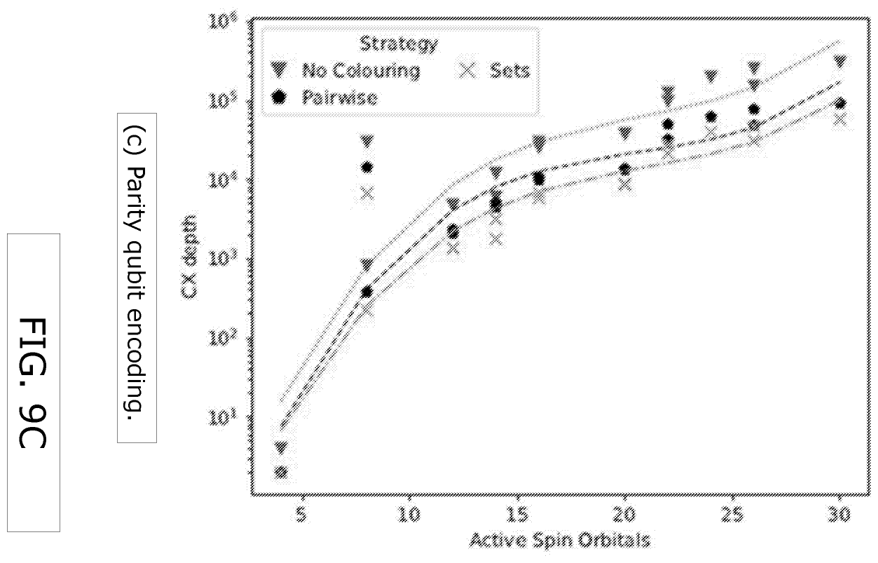

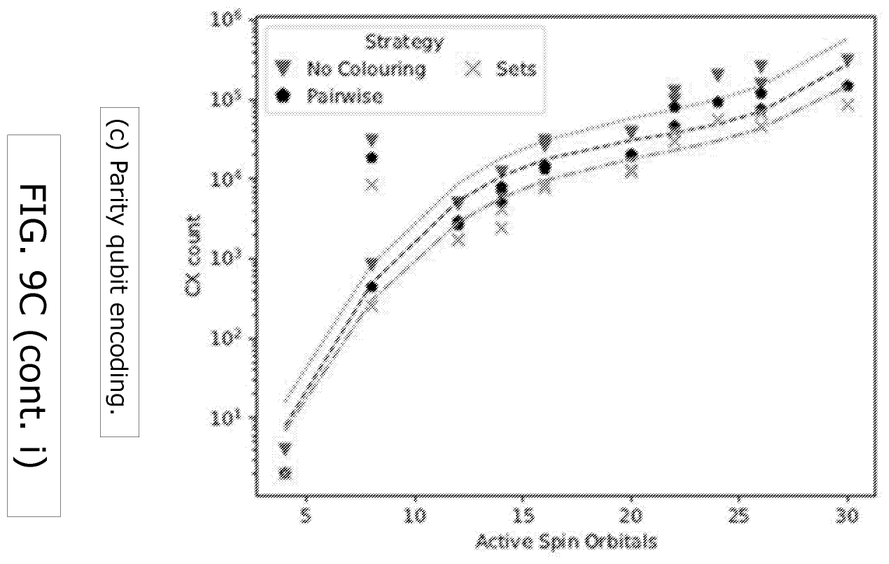

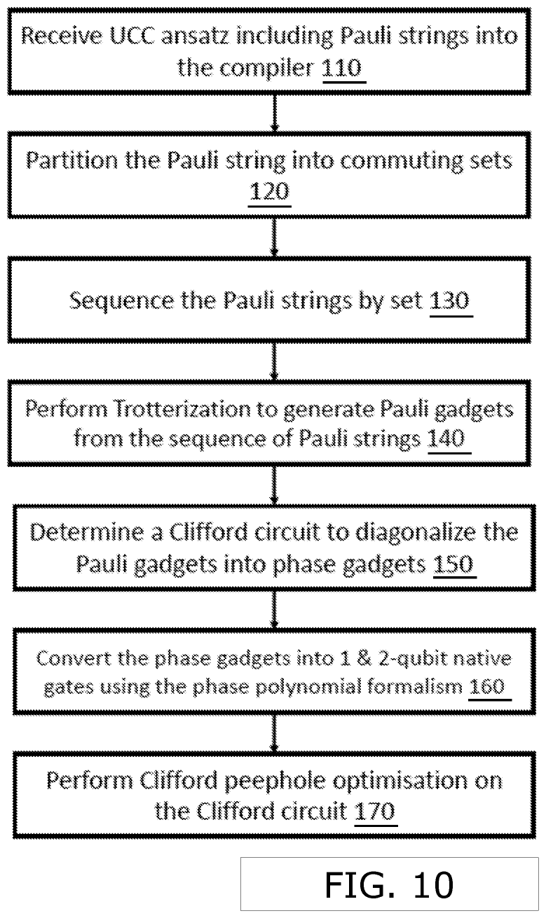

FIG. 10 is a flowchart that is an illustration of an example of performing a compilation in accordance with the compilation strategy disclosed herein; and

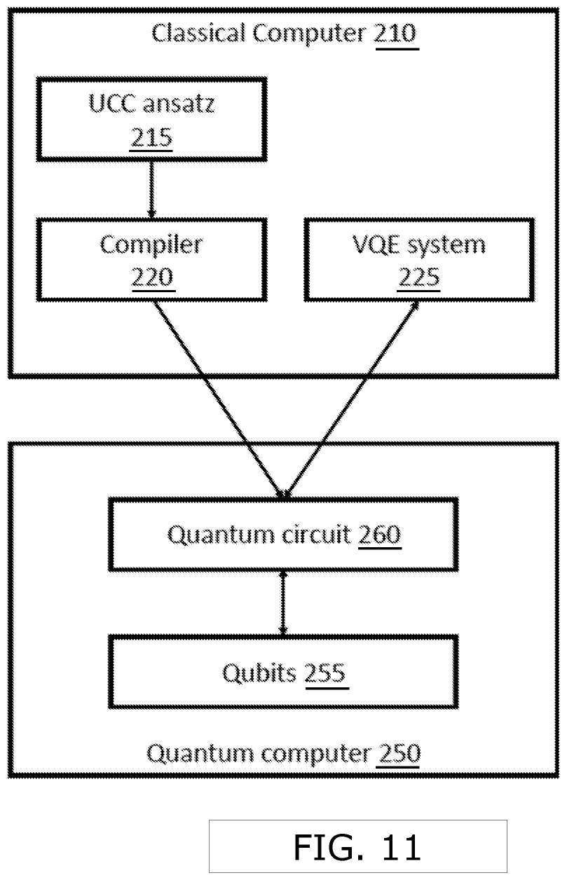

FIG. 11 is a schematic illustration of a computing environment for utilising a compilation strategy as disclosed herein.

### DETAILED DESCRIPTION

In overview, the present disclosure relates to methods and systems for generating quantum circuits; the methods and systems are defined in appended claims and are described below in detail. Moreover, the systems and methods are susceptible to being used to generate a quantum circuit from a Unitary Coupled Cluster (UCC) Ansatz. In embodiments of the present disclosure, the UCC Ansatz represents an excitation of a reference state by a parameterised operator including excitation operators. The UCC Ansatz includes multi-qubit Pauli operators, referred to as “Pauli strings”; one or more Pauli strings are determined from each corresponding excitation operator.

In embodiments of the present disclosure, a method for generating a quantum circuit includes partitioning Pauli strings into mutually commuting sets and sequencing the Pauli strings by set. The method further includes generating Pauli gadgets from the Pauli strings. The Pauli gadgets have a same sequencing by set as the Pauli strings. Generating Pauli gadgets from the Pauli strings is accomplished by performing Trotterization. Each set of Pauli gadgets is diagonalised to convert the Pauli gadgets into corresponding phase gadgets which are then transformed into one- and two-qubit native gates to generate the quantum circuit.

Moreover, the present disclosure provides a system and a method for generating a quantum circuit, in which a computer-implemented method comprises generating a quantum circuit from a Hamiltonian using a parameterised operator which is provided in, or can be mapped to, its Pauli decomposition (namely, a sum over a collection of Pauli operators/strings); Pauli operators of the Pauli decomposition are conveniently referred to as being “Pauli strings” as aforementioned. The method comprises:
(i) partitioning the Pauli strings into mutually commuting sets and sequencing the Pauli strings by set;
(ii) generating Pauli gadgets from the Pauli strings by performing Trotterization, wherein the Pauli gadgets have a same sequencing by set as the Pauli strings;
(iii) diagonalising each set of Pauli gadgets to convert the Pauli gadgets into corresponding phase gadgets; and
(iv) transforming the phase gadgets into one- and two-qubit native gates to generate the quantum circuit.

Beneficially, for example, the Hamiltonian includes excitation operators to represent an excitation of a reference state, wherein multi-qubit Pauli operators are determined from each excitation operator. In other examples, the Hamiltonian uses a parameterised operator without excitation operators.

Furthermore, as disclosed herein, the present disclosure provides a system and method for generating a quantum circuit from a Unitary Coupled Cluster (UCC) Ansatz which represents an excitation of a reference state by a parameterised operator including excitation operators. The UCC Ansatz includes multi-qubit Pauli operators determined from each excitation operator; the Pauli operators are referred to as being “Pauli strings” as aforementioned. The method comprises:
(i) partitioning the Pauli strings into mutually commuting sets and sequencing the Pauli strings by set;
(ii) generating Pauli gadgets from the (partitioned) Pauli strings by performing Trotterization, the Pauli gadgets having a same sequencing by set as the Pauli strings;
(iii) diagonalising each set of Pauli gadgets to convert the Pauli gadgets into corresponding phase gadgets; and
(iv) transforming the phase gadgets into one- and two-qubit native gates to generate the quantum circuit.

A compilation strategy provided by such a system and method helps to reduce significantly a circuit depth and entangling gate count of the aforesaid quantum circuit. Having a smaller entangling gate count helps to reduce the rate of errors due to stochastic noise. This may then help to reduce or avoid reliance on error handling strategies such as repeating computations and/or using codes for error detection and/or correction. Having a smaller circuit depth helps to provide quicker results, which firstly increases the efficiency of the quantum circuit (and any computer system of which it is a part), and also helps to reduce susceptibility to stochastic noise (since both the peak and cumulative amount of noise are likely to be smaller with a shorter execution time).

Benchmarks on realistic molecules that can be simulated using the system and method show that using such a strategy is susceptible to reduce substantially a number of entangling gates required and also a circuit depth of the aforesaid quantum circuit. For example, in one investigation, a reduction of an average of 75%, and by up to 89% in the number of entangled gates was achievable compared to a naïve compilation strategy employed by a standard compiler such as IBM's Qiskit.

The present disclosure provide a compilation strategy that may be utilised in a situation which still involves a Trotterized Hamiltonian, but which does not necessarily utilise the UCC Ansatz. One example of such a further application is for a Quantum Approximate Optimization Algorithm (QAOA). QAOA is susceptible for being used to implement solutions for general combinatorial optimisation problems; examples problems include supply-line optimization problems, register allocation problems in computing hardware, as well as job scheduling problems.

According to an aspect of the disclosure, there is provided systems and methods described herein, for example a computer-implemented method for (namely, a method of) generating a quantum circuit from a Unitary Coupled Cluster (UCC) Ansatz which represents an excitation of a reference state by a parameterised operator including excitation operators, wherein the UCC Ansatz includes multi-qubit Pauli operators, referred to as “Pauli strings”, determined from each excitation operator, wherein the method comprises:
(i) partitioning the Pauli strings into mutually commuting sets and sequencing the Pauli strings by set;
(ii) generating Pauli gadgets from the Pauli strings by Trotterization, wherein the Pauli gadgets have the same sequencing by set as the Pauli strings;
(iii) diagonalising each set of Pauli gadgets to convert the Pauli gadgets into corresponding phase gadgets; and
(iv) transforming the phase gadgets into one- and two-qubit native gates to generate the quantum circuit.

As aforementioned, a computer-implemented method for (namely, method of) generating a quantum circuit from a Unitary Coupled Cluster (UCC) Ansatz is provided. The aforesaid method optionally includes one or more following features independently or in combination with one or more other features. In example embodiments of the present disclosure, partitioning the Pauli strings into mutually commuting sets seeks to reduce the number of sets; this partitioning potentially increases a speed of quantum computation as well as decreasing computational error rate. However, such a step seeks to improve an effectiveness of the diagonalisation and phase polynomial synthesis, which are the bits that actually reduce the redundancy compared to the naïve solution. Beneficially, the number of sets is reduced to a minimum consistent with providing a desired computational function for the quantum circuit. In example embodiments of the present disclosure, the partitioning is optionally performed using a graph colouring algorithm; such an algorithm assists to identify the sets, thereby enabling the quantum circuit to be generated more efficiently. In example embodiments of the present disclosure, a phase gadget is a Pauli gadget comprising only Z and I letters; the Z and I letters are representative of Pauli gadget operating parameters. In example embodiments of the present disclosure, each set of Pauli gadgets is diagonalised using a Clifford circuit; such diagonalization concerns a numerical technique for solving quantum Hamiltonians. Exact diagonalization (ED) is a numerical technique used in physics to determine eigenstates and energy eigenvalues of a quantum Hamiltonian.

In example embodiments of the present disclosure, each set of Pauli gadgets is represented as:
(i) a Clifford circuit;
(ii) a set of phase gadgets, and
(iii) an inverse Clifford circuit.

Moreover, such Clifford circuits transform between an original basis of the Pauli gadgets and a new basis in which the Pauli gadgets are represented by a corresponding set of phase gadgets. In example embodiments of the present disclosure, in which for two qubits i and j, and S being a set of m mutually commuting Pauli gadgets and σₖₗ a Pauli letter on qubit k from Pauli gadget l, the qubit i or j is diagonalised by conjugating with at most one entangling gate and two single-qubit Clifford gates on each side of S between the qubits i and j, providing Equation 1 (Eq. 1):

∃A,B∈{X,Y,Z}s.t.∀l∈{1, . . . ,m},σᵢₗ∈{I,A}⇔σⱼₗ∈{I,B} Eq. 1

Optionally, the diagonalisation is performed by:
(i) finding a Pauli string with a lowest weight;
(ii) conjugating the corresponding Pauli gadget with a single-qubit Clifford gate and entangling gates; and
(iii) commuting the Clifford gates through the rest of the Pauli gadgets until all the Clifford gates are outside the adjacent Pauli gadgets.

Optionally, transforming the phase gadgets into one- and two-qubit native gates to generate the quantum circuit includes using a phase polynomial formalism; more optionally, transforming the phase gadgets by using the phase polynomial formalism includes using a GraySynth procedure. Such a GraySynth procedure is defined as being a particular algorithm that is pre-existing in literature. In overview, “GraySynth orders the phase gadgets to maximise a similarity between strings of consecutive gadgets, then synthesises them by using CX gates to compute parities, and by using RZ gates to introduce a phase from each gadget. The maximisation of similarities minimises the number of CX's required to change parity between corresponding RZ gates.

Optionally, the method further comprises performing a Clifford peephole optimisation by finding patterns of two-qubit Clifford circuits and replacing them with equivalent circuits with lower counts of entangling gates; such an optimization reduces quantum computation time as well as reducing quantum computation error rate for the quantum circuit. Optionally, performing Clifford peephole optimisation is performed by finding patterns of two-qubit Clifford circuits and replacing them with equivalent circuits with lower counts of entangling gates, wherein performing the Clifford peephole optimisation comprises finding small patterns of two-qubit Clifford circuits and replacing them with equivalent circuits with lower counts of entangling gates. Optionally, the method reduces the count and depth of entangling gates of the quantum circuit relative to a naïve synthesis of the quantum circuit from the Pauli strings; the method reduces the complexity of the quantum circuit with associated benefits of reduced computational error and faster computation. Optionally, the method includes configuring the quantum circuit using an UCC Ansatz corresponding to a molecular structure; however, other types of UCC Ansatz can be employed, for example corresponding to system optimization, variational inference, signal filtering, genetic data processing to find phenotypes and associated single nucleotide polymorphisms (SNP's) and so forth. Optionally, the UCC Ansatz corresponds to a quantum system which has a Hamiltonian which is subject to Trotterization. Trotterization is a method for converting a given Hamiltonian into smaller objects that are more amenable to implementation on a quantum computer.

In an example embodiment of the disclosure, the method is used to generate a quantum circuit based on a Trotterized Hamiltonian, but without using a UCC Ansatz. Optionally, the Trotterized Hamiltonian corresponds to a Quantum Approximate Optimization Algorithm (QAOA).

According to an aspect of the present disclosure, for systems, techniques and methods described herein, a compiler is configured to perform any and all of the aforesaid methods.

Optionally, for the concepts, systems and techniques as described herein, a system is used, wherein the system comprises at least one processor and a compiler configured to run on the at least one processor to generate a quantum circuit from a Unitary Coupled Cluster (UCC) Ansatz which represents an excitation of a reference state by a parameterised operator including excitation operators; the UCC Ansatz includes multi-qubit Pauli operators, referred to as Pauli strings, determined from each excitation operator. The compiler is configured:
(i) to partition the Pauli strings into mutually commuting sets and to sequence the Pauli strings by set;
(ii) to generate Pauli gadgets from the Pauli strings by Trotterization, wherein the Pauli gadgets have a same sequencing by set as the Pauli strings;
(iii) to diagonalise each set of Pauli gadgets to convert the Pauli gadgets into phase gadgets; and
(iv) to transform the phase gadgets into one- and two-qubit native gates to generate the quantum circuit.

According to an aspect of the present disclosure, for concepts, systems and techniques described herein, there is provided a method for running a Variational Quantum Eigensolver (VQE) as a hybrid quantum-classical algorithm to approximate the ground state of some Hamiltonian, wherein the method includes using a subroutine performed on a quantum computer inside a larger optimization routine performed on a classical computer, wherein the subroutine utilises a quantum circuit formed by diagonalising sets of Pauli gadgets to convert the Pauli gadgets into phase gadgets and transforming the phase gadgets into one- and two-qubit gates. Optionally, the method is performed to simulate a quantum system for determining the ground state of the quantum system.

According to an aspect of the present disclosure, with respect to concepts, systems and techniques described herein, there is provided a system for running a Variational Quantum Eigensolver (VQE) as a hybrid quantum-classical algorithm to approximate a ground state of a given Hamiltonian using a subroutine performed on a quantum computer inside a larger optimization routine performed on a classical computer, wherein the subroutine utilises a quantum circuit formed by diagonalising sets of Pauli gadgets to convert the Pauli gadgets into phase gadgets and transforming the phase gadgets into one- and two-qubit gates.

According to an aspect of the present disclosure, with respect to concepts, systems and techniques described herein, there is provided a computer-implemented method for (namely, method of) generating a quantum circuit from a Hamiltonian using a parameterised operator including excitation operators to represent an excitation of a reference state, wherein the method includes determining multi-qubit Pauli operators, referred to as Pauli strings, from each excitation operator, wherein the method further comprises:
(i) partitioning the Pauli strings into mutually commuting sets and sequencing the Pauli strings by set;
(ii) generating Pauli gadgets from the Pauli strings by Trotterization, wherein the Pauli gadgets have a same sequencing by set as the Pauli strings;
(iii) diagonalising each set of Pauli gadgets to convert the Pauli gadgets into corresponding phase gadgets; and
(iv) transforming the phase gadgets into one- and two-qubit native gates to generate the quantum circuit.

Optionally, the Hamiltonian corresponds to a Quantum Approximate Optimization Algorithm (QAOA).

According to an aspect of the present disclosure, with regard to concepts, systems and techniques described herein, there is provided a system that includes at least one processor and a compiler configured to run on the at least one processor to generate a quantum circuit from a Hamiltonian using a parameterised operator including excitation operators to represent an excitation of a reference state, wherein multi-qubit Pauli operators, referred to as Pauli strings, are determined from each excitation operator, wherein the compiler is configured:
(i) to partition the Pauli strings into mutually commuting sets and to sequence the Pauli strings by set;
(ii) to generate Pauli gadgets from the Pauli strings by Trotterization, wherein the Pauli gadgets have a same sequencing by set as the Pauli strings;
(ii) to diagonalise each set of Pauli gadgets to convert the Pauli gadgets into phase gadgets; and
(iv) to transform the phase gadgets into one- and two-qubit native gates to generate the quantum circuit.

In general overview, the present disclosure provides (inter alia) a compilation strategy for Variational Quantum Eigensolver (VQE) algorithms which use a Unitary Coupled Cluster (UCC) Ansatz. This compilation strategy is designed to reduce a quantum circuit depth and a corresponding gate count; such a reduction reduces quantum computation time and also reduces quantum computation error rate as beneficial technical effects.

In general terms, in embodiments of the present disclosure, there is used a compilation strategy that partitions terms from a UCC Ansatz into mutually commuting sets, based on an equivalence between such a sequencing problem and a graph colouring; such colouring will be described in more detail below. These sets are then diagonalised using Clifford circuits and synthesised using a phase polynomial formalism, for example as aforementioned. Approximate solutions to such an approach enable a large-scale synthesis of Pauli exponentials into one- and two-qubit gates to be achieved; moreover, heuristics are described for performing this large-scale synthesis to generate low depth quantum circuits. It will be appreciated that a one-qubit gate has a single qubit input and a single qubit output, whereas a two-qubit gate, which also represents an entangling gate, has two qubit inputs and two qubit outputs.

Such a compilation strategy helps to reduce a major source of error affecting the aforesaid VQE algorithm; the major source of error pertains to noise of a quantum device that is used, for example a quantum computer. The compilation strategy increases quantum circuit fidelity by reducing a quantum circuit depth, thereby helping to reduce, for example to minimise, the number of noisy gates required for implementing the quantum circuit and an exposure of its qubits to decoherence when the quantum circuit is in operation. Noise and decoherence are physical phenomena that occur in real physical hardware, and represent an objective technical problem that embodiments of the present disclosure are able to address.

The compilation strategy is susceptible to being used for any Ansatz which is generated by Trotterization of an operator made up of a sum of Pauli tensor products. Accordingly, the compilation strategy is susceptible to being applied to a UCC Ansatz, including for example a k-UpCCGSD Ansatz and other variations on a UCCSD Ansatz, such as a UCCGSD Ansatz [27]; however, embodiments of the present disclosure are not primarily intended for a so-called “hardware efficient” Ansatz [117]). Compilation of an Ansatz using the aforesaid compilation strategy does not require a trade-off in accuracy or convergence rate. Compilation strategies of the present disclosure are generic, and do not require prior knowledge of a qubit encoding, a target Hamiltonian or a basis set.

Potential applications of the aforesaid Unitary Coupled Cluster (UCC) method and Ansatz (and hence the compilation strategy described herein) include but are not limited to:
(a) Solid state physics: for undertaking simulations for manufacturing semiconductor devices, for modelling semiconductor devices, for controlling semiconductor manufacturing processes; there is beneficially used a Dynamical Mean Field Theory approach [111], wherein examples include an Anderson impurity model [112] and a Hubbard model [113];
(b) Condensed matter simulations with periodic boundary conditions; for example, for modelling and control of processes for transmuting elements and for low-energy nuclear reaction (LENR) power generation;
(c) Quantum optics: for undertaking simulation, design and manufacture of quantum optical devices, for example future optical quantum computers utilizing photon optical entanglements, for example utilizing a Jaynes-Cummings model [114];
(d) Nuclear physics: for simulating subatomic particle interactions, for designing apparatus to generate antimatter (for example antimatter propulsion as has been proposed by NASA), for simulating processes to generate antimatter, and for simulating subatomic particles in general [115]; and
(e) Any quantum system which has a Hamiltonian which is subject to Trotterization, wherein the Hamiltonian represents an energy of a quantum system; Trotterization is a method to convert the Hamiltonian into smaller objects that are more amenable to implementation on a quantum computer.

The aforesaid compilation strategy described herein has been implemented in t|ket [symbol] , wherein t|ket [symbol] is a retargetable compiler developed by Cambridge Quantum Computing Ltd, [103], to obtain benchmarks for a variety of UCC Ansatz circuits, for example for simulating realistic molecules. Results using the compiler t|ket [symbol] demonstrate empirically that the compilation strategy described herein helps to reduce significantly a two-qubit gate count and depth. For example, the compilation strategy has been found to reduce ∧X depth by 77.5% on average, and by up to 89%, compared to naive synthesis, for a variety of molecules, qubit encodings and basis sets.

### 1. Definitions

The following terminology is adopted in this present disclosure:

“Pauli”: a Pauli is a single-qubit operator, for example a quantum gate. There are four Paulis, corresponding to 3 orthogonal axes (X, Y, Z) and I (an identity operator). See an earlier document [107], in which Ox denotes a Pauli-X, and so on for other axes.

“Pauli string”: a Pauli string, or multi-qubit Pauli operator, is a tensor product of two or more single-qubit Paulis (I, X, Y, Z). Pauli strings commute under addition, but do not necessarily commute under multiplication.

“Pauli exponential”: this is an exponentiated Pauli string.

“Pauli gadget”: a Pauli gadget is used to denote a particular representation of a Pauli exponential; in effect therefore, a Pauli exponential is a Pauli gadget and vice versa.

“Phase gadget”: a phase gadget is a Pauli gadget in which all the Paulis in the exponentiated Pauli string are either I or Z. This exponentiated Pauli string (based on I and/or Z Paulis) is diagonal in form, and so converting arbitrary exponentiated Pauli strings (Pauli gadgets) into phase gadgets is referred to as “diagonalisation”.

“∧X gates”: these are also known as CX or CNOT gates. They are a type of “entangling gate”, namely a gate which has 2-qubit inputs. These gates are a most significant part of a quantum circuit, in the sense that they generally contribute most quantum noise to the quantum circuit when in operation; such quantum noise is susceptible to causing quantum decoherence that is manifest as quantum computational errors. Accordingly, the number of these ∧X gates is an important metric in the quantum circuit, alongside a depth of the ∧X gates, namely the number of parallel layers of ∧X gates that must be performed to complete the quantum circuit. It will be appreciated that increasing quantum circuit depth implies that additional time is required to complete a quantum computation, and such additional time also presents an increased risk that the quantum computation is subject to noise and decoherence as aforementioned.

It will be appreciated that ∧X gates are just one type of entangling gate that can be used when constructing or configuring quantum circuits, and one or more other types of entangling gate are susceptible to being utilised instead of, or as well as, aforesaid ∧X gates. Accordingly, where the present disclosures refers to ∧X gates, this is not intended to be by way of limitation, and it will be understood that corresponding reductions in gate count and depth may also be achieved for implementations utilising other types of entangling gate in conjunction with the approaches and methods as described herein.

It will be appreciated that many different types of contemporary quantum computers have been designed and used for performing quantum computations. For example, some designs of quantum computer utilize superconducting devices that have to be cooled to temperatures close to absolute zero temperature in order to function. Moreover, for example, other designs of quantum computer utilize optical components wherein qubits are implemented as individual photons; such quantum computers utilizing optical components are potentially susceptible to functioning at relatively higher temperatures, potentially at room temperature with optical devices microfabricated onto compact substrates. Furthermore, quantum computers utilizing ion traps have also been demonstrated. However, it will be appreciated that approaches, strategies and methods of the present disclosure are susceptible to being used with each of these mutually different types of quantum computer, to reduce their computational error rate and also to increase their quantum computational speed.

### 2. Unitary Coupled Cluster (UCC) Ansatz

A Unitary Coupled Cluster Ansatz is defined by an excitation of some reference state by an operator parameterised with coupled cluster amplitudes \vec{t}: as defined by Equation 2 (Eq. 2):

|Ψ(\vec{t}) [symbol] =U(\vec{t})|Φ₀ [symbol] =e^{T(\vec{t})-T}^{^{\}}^{(\vec{t})}|Φ₀ [symbol] Eq.2

wherein a left-hand term of Equation 2 defines quantum properties of a system being modelled, which is specified as part of input to an associated VQE algorithm, and a middle term of Equation 2 represents a parameterised operator applied to an initial quantum state, also referred to as a UCC reference state. An operator T in Equation 2 contains fermionic excitation operators \vec{τ} such that a corresponding parameterised operator can be rewritten as provided in Equation 3 (Eq. 3):

U(\vec{t})=e^{Σ}^{ⱼ}^{t}^{ⱼ}^{(T}^{ⱼ}^{-T}^{ⱼ}^{^{\}}⁾ Eq.3

This parameterised operator cannot be directly implemented on a gate-based quantum computer. It must be mapped to qubits and decomposed into native gates. Next, there is described a method for mapping the parameterized operator to such qubits and decomposed into native gates.

In order to generate a quantum circuit, the method first employs Trotterization, as justified by Lloyd [29]. Optionally, there is used a first order Trotterization in which the parameterised operator is approximated by a product of exponential terms dependent on fermionic excitation operators as defined by Equation 4 (Eq. 4):

$$U ( \vec{t} ) \approx {U}_{Trott} ( \vec{t} ) = ( {\prod }_{j} {e}^{\frac{{i}_{j}}{ρ} ( {τ}_{j} - {τ}_{j}^{†} )} ) ρ \qquad Eq . 4$$

wherein ρ is a Trotter step size. Beneficially, it is assumed that ρ=1 for near-term cases.

To implement a Trotterized expression as shown in Equation 4 on a quantum computer, the method includes mapping the parameter τⱼ in a product to operations acting on qubits of a quantum circuit. This can be performed using a variety of qubit encodings, such as Bravyi-Kitaev (BK), Jordan-Wigner (J W) and Parity (P) [36]. These encodings have different resource requirements, and the qubits are given different semantic meanings, but, regardless of choice, there is provided a mapping as defined in Equation 5 (Eq. 5):

$$( {τ}_{j} - {τ}_{j}^{†} ) = {ia}_{j} {\sum }_{k} {P}_{jk} \qquad Eq . 5$$

wherein aⱼ∈ [symbol] and Pⱼₖ∈{I,X,Y,Z}^{⊗n}.

An element of {I,X,Y,Z}^{⊗n} is referred as being a “Pauli string”, composed of letters from an alphabet{I,X,Y,Z}. Such Pauli strings represent multi-qubit Pauli operators and are effectively supplied, as described below, by the UCC Ansatz, wherein the UCC Ansatz and its corresponding Pauli strings are in accordance with a given quantum system that is to be simulated. A given Pauli string has a “weight”: that is a number of non-I letters that the given Pauli string contains. It can be shown that corresponding Pauli strings Pⱼₖ from a given excitation operator τⱼ always commute under multiplication [35]. Such a characteristic then allows an expression for the Trotterized operator to be derived as provided in Equation 6 (Eq. 6):

$${U}_{Trott} ( \vec{t} ) = {\prod }_{j} {\prod }_{k} {e}^{{it}_{j} {a}_{j} {P}_{jk}} \qquad Eq . 6$$

wherein the terms e^{it}^{ⱼ}^{a}^{ⱼ}^{P}^{ⱼₖ} are parameterised with some angle tⱼ for a variational algorithm pursuant to the present disclosure. These parameterised terms represent “Pauli exponentials”, and relabelling of coefficients provides t′ⱼ=tⱼaⱼ. Pauli exponentials can be implemented on a quantum computer by decomposition into one- and two-qubit native gates, as described in greater detail below (see Pauli Exponentials).

For noisy intermediate quantum scale (NISQ) devices, two-qubit gates typically have error rates around an order of magnitude higher than one-qubit gates, as well as typically requiring in a range of 2 to 5 times as long to operate compared with one-qubit gates [38, 10]. Accordingly, reducing, for example minimising, the two-qubit gate count and depth is an important aim for a compilation strategy according to the present disclosure.

### 3. Term Sequencing

Referring to aforesaid Equation 3 (Eq. 3), an expansion of fermionic excitation operators at this stage into Pauli strings using Equation 5 (Eq. 5) is beneficially implemented as provided in Equation 7 (Eq. 7):

U(\vec{t})=e^{iΣ}^{ⱼ}^{Σ}^{ₖ}^{t′}^{ⱼ}^{P}^{ⱼₖ} Eq.7

It will be appreciated that Pⱼₖ terms all commute under addition. It is only after the Trotterization step that corresponding Pauli exponentials do not commute. It is therefore advantageous to sequence the Pauli strings at this stage in a beneficial order, such that an associated Trotterization incurs minimal Trotter error and a resulting quantum circuit has low resource requirements. It is generally thought that reducing Trotter error should be a secondary concern for VQE, compared with a focus on minimising ∧X gate count and depth.

According to the aforesaid approach to reduce the count and depth of the ∧X gates, it is beneficial to partition the set of Pauli strings into a small number of subsets, such that within a given subset every Pauli string commutes under multiplication. This problem is known in the literature on measurement reduction [22, 18, 40] and can be represented as a graph problem. The present disclosure provides a solution to this graph problem that may be utilised in generating a quantum circuit pursuant to the present disclosure.

3.1 Graph Colouring

A graph colouring method such as used in methods of the present disclosure helps to create sets that contribute to generating quantum circuits that have less depth and faster computation rate when implementing a given computation function, for example a simulation of a molecule, control of a real physical system, processing sensor signals and such like. As aforementioned, less depth results in reduced errors and stochastic noise when performing quantum computations. When performing graph colouring, each Pauli string is represented as a vertex in an undirected graph. An edge is given between any two vertices that correspond to Pauli strings which anti-commute. In FIG. 1, there is shown an example of an example graph representation. Finding a minimum number of mutually commuting sets which cover all vertices in this graph representation is then equivalent to a colouring problem, a known NP-hard problem, namely a form of feature tagging. Accordingly, in FIG. 1, there is shown a graph colouring to partition a given Pauli string into sets of mutually commuting strings. It will be appreciated, whereas parameters are not shown in FIG. 1, they are tracked for synthesis later as will be described below.

In methods of the present disclosure, there is used a simple, “largest first” greedy colouring algorithm to partition a given plurality of Pauli strings [1]. The algorithm has a complexity [symbol] (mn), wherein m denotes a number of Pauli strings and n denotes a number of qubits, although building an associated initial anti-commutation Pauli graph scales as (m²n). A partitioning shown in FIG. 1 has generated two sets, wherein one of the sets is labelled blue and the other set is labelled pink; it will be appreciated that colours are not allowed in the diagrams of the present disclosure, hence colour labelling is employed to denote colour.

Once the vertices have been assigned colours, namely each vertex has been allocated to a set, a UCC reference state is prepared using a short quantum circuit, and the corresponding Pauli strings are appended, colour by colour (namely, set by set), in lexicographical order. For example, given the graph colouring solution from FIG. 1, a valid ordering of strings is: IIXY, IIYX, XYII, YXII, XXXY, XXYX, XYXX, XYYY, YXXX, YXYY, YYXY, YYYX.

In other words, this approach orders the Pauli strings by set, wherein each set comprises mutually commutating Pauli strings under multiplication, such that the Pauli strings from one set are together (contiguous), and then the Pauli strings from another set, and so on in a sequence. In effect, the Pauli strings are therefore partitioned by set. It will be appreciated that the ordering of the sets themselves, namely which set is first in the sequence, which set is second in the sequence, and so on, is optionally arbitrary, as long as a contiguity of each set is maintained. Likewise, the ordering of the Pauli strings within a given set is arbitrary; in other words, the ordering does not have to be lexicographical. Such a set-by-set ordering of the Pauli strings is carried over into a sequence of corresponding Pauli exponentials which are derived by Trotterization from the corresponding Pauli strings.

### 4. Pauli Exponentials

In order to elucidate strategies, methods and embodiments of the present disclosure more comprehensively, notations used will next be described. In order to reason about and represent a synthesis of a quantum circuit from Pauli exponentials, it is advantageous to use notation inspired by ZX-calculus [14], although the strategies of the present disclosure can be followed without requiring knowledge of inference rules of aforesaid calculus. A translation of relevant gates between the quantum circuit and ZX-calculus formalisms is given in FIG. 2. In particular, FIG. 2 comprises three columns, wherein each column represents common circuit gates (left) and their representations in the aforesaid scalar-free ZX-calculus (right). The left-most column shows circles having a white background or fill for operations with respect to the Z axis (in the literature, a green colour is often used to denote these operations), while the central column shows circles with a shaded background or fill for operations with respect to the X axis (in the literature, a red colour is sometimes used to denote these operations). An S gate corresponds to

$$R z ( \frac{π}{2} )$$

and a V gate to

$$R x ( \frac{π}{2} ) .$$

A brief introduction to the ZX-calculus is found in Fagan & Duncan [19]; for a complete treatment see Coecke & Kissinger [15].

4.1 Phase Gadgets

In the present disclosure, there is adopted a notation of “phase gadgets” in which ϕn(a) is equivalent to an operator

$${e}^{- i \frac{α}{2} {Z}^{⊗ n}} .$$

Such a notation is consistent with the definition above that phase gadgets are Pauli exponentials, or equivalently Pauli gadgets, in which all the Paulis are Z and/or I. These phase gadgets are described in Kissinger & van de Wetering [24], and have a natural representation in the aforesaid ZX-calculus. In FIG. 2A, there are shown representations of ϕn(a) in the ZX-calculus notation. Associated algebra for phase gadgets and alternative decompositions into one- and two-qubit gates are given in [106]. In FIG. 2A, there is a shading representation that is the same as described above in relation to FIG. 2, with the phase gadgets having a white (unshaded) background/fill since they involve operations with respect to the Z axis.

Note that the horizontal lines in FIG. 2A, and more generally in diagrams for the ZX-calculus, correspond to qubits; hence, three qubits are explicitly shown in FIG. 2A but more are implied by the vertical dotted lines. In a left-hand diagram in FIG. 2A, there is shown an n-input gate wherein n>2, which cannot however be physically implemented directly; the right-hand diagram in FIG. 2A is an illustration of an equivalent circuit formed only from two-qubit gates.

4.2 Pauli Gadgets

A correspondence between phase gadgets and Pauli-Z exponentials generalises to any Pauli exponential,

$${e}^{- i \frac{α}{2} {σ}_{1} {σ}_{2} … {σ}_{n}} ,$$

by conjugating a given phase gadget with a corresponding single-qubit Clifford gates ([104]). In other words, it is feasible to generate any Pauli gadget (namely Pauli exponential) by conjugating a phase gadget with one or more single-qubit Clifford gates.

In FIG. 2B, there is shown an illustration of a Pauli-gadget diagrammatic notation for Pauli exponentials from a publication Cowtan et al. [17], wherein Pauli exponentials are represented succinctly using the ZX-calculus notation of FIG. 2A. The white, diagonally split, and shaded boxes shown in a right-hand portion of FIG. 2B respectively represent a Pauli gadget acting on a qubit in X, Y, and Z bases (the same representations are adopted in the other Figures as appropriate). These Pauli exponentials are, for example, formed by a phase gadget acting on qubits (generating all Z interactions), and then conjugating the qubits with appropriate single-qubit Clifford gates. The Clifford gates are susceptible to being commuted through Pauli gadgets, but potentially incur a phase flip or basis change. Rules to perform this procedure for relevant Clifford gates are provided in a publication [106].

For a set of m Pauli gadgets over n qubits, there are required [symbol] (nm)∧X gates for naive synthesis. Specifically, at most 2m(n-1) *CX* gates are required, plus up to mn+m+n additional single-qubit gates are also needed; this happens if there are no I's in any of the Pauli strings. Thus, there is proposed herein a heuristic which synthesises a quantum circuit from a commuting set of Pauli gadgets, wherein this heuristic results in a reduced number of ∧X gates, compared with the naive synthesis, for realistic examples found in UCC Ansatz circuits.

### 5. Set-Based Synthesis

For set-based synthesis, an approach disclosed herein in the present disclosure includes three steps, namely:
1) Diagonalisation: every Pauli gadget in a given commuting set is simultaneously converted into a phase gadget by conjugating with an appropriate Clifford circuit.
2) Phase gadget synthesis: the resulting phase gadgets are converted into ∧X and Rz gates using a well-studied phase polynomial formalism as described in a publication [9].
3) Clifford peephole optimisation: two-qubit Clifford subcircuits are optimised using graph rewriting techniques as described in a publication [19].

In relation to terminology used, an adjacent sequence of Pauli gadgets is diagonal when every Pauli string is only over Z and I letters, namely every Pauli gadget is a phase gadget. A qubit is diagonal over a set when, for every Pauli string in that set, the Pauli letter on that qubit is either a Z or I. A Clifford circuit is a circuit formed from Clifford gates.

5.1 Diagonalisation

From the foregoing, it will be appreciated that [A, B]=0⇔[U AU^{\}, U BU^{\}]=0 for unitaries A, B and U. From such a relationship, it is feasible to conjugate Pauli gadgets with Clifford gates while maintaining commutation between all gadgets. Given an initial commuting set of Pauli gadgets S, the methods of the present disclosure include searching for a Clifford circuit C and phase gadget circuit S′ such that, as defined by Equation 8 (Eq. 8):

S=CS′C^{\} Eq.8

Equation 8 can be regarded as a change in basis from an initial basis of Pauli gadgets to a new basis in which a set of Pauli gadgets is diagonalised, namely the set of Pauli gadgets can be represented by a set of phase gadgets S′. A motivation here is that although the Clifford gates represent additional gates compared with the original Pauli gadgets S, this is more than compensated for by a compact gate implementation of the diagonalised phase gadgets S′ compared with a direct gate implementation for the original Pauli gadgets S. In other words, a reduction achieved by transitioning from Pauli gadgets to phase gadgets outweighs the additional Clifford gates used to accomplish such a transition.

In general, it is desirable to perform diagonalisation on largest possible sets of Pauli exponentials, namely Pauli gadgets S, as the bigger the set the more efficient the compilation becomes when implemented using phase polynomial synthesis, as described below. Accordingly, this increased efficiency provides a motivation to gather the Pauli strings, which will become the Pauli exponentials, into sets, and to sequence the Pauli strings by set, as described above.

Jena et al. previously disclosed an algorithm that is guaranteed to give such a Clifford circuit C [22], although this algorithm is inefficient in terms of ∧X gates.

For m Pauli gadgets, Crawford et al. has recently presented two efficient constructions of C with a bound of mn−m(m+1)/2 and [symbol] (mn/log m) ∧X gates respectively, when m<n [18]. When m≥n, the construction provided by Aaronson and Gottesman requires [symbol] (n²/log n) ∧X gates, as described in publications [2, 30].

It will be appreciated that a ∧X count of a Clifford circuit used for diagonalisation is typically much less than an asymptotic worst case for realistic examples in UCC Ansatz circuits. As elucidated in greater detail below, a heuristic can be based on diagonalising a qubit from a two-qubit chain.

5.1.1 Diagonalising a Two-Qubit Chain

Next, a Theorem 5.1 will be described in greater detail that is relevant to implementing methods of the present disclosure. Given two qubits i and j, let S be a set of m mutually commuting Pauli gadgets, and σₖₗ a Pauli letter on qubit k from gadget I. Conjugating with at most one ∧X and two single-qubit Clifford gates on each side of S between qubits i and j is sufficient to diagonalise either qubit i or j iff, as provided in Equation 9 (Eq. 9):

∃A,B∈{X,Y,Z}s.t.∀l∈{1, . . . ,m},σᵢₗ∈{I,A}⇔σⱼₗ∈{I,B} Eq. 9

Next, a proof of the Theorem 5.1 is provided.

Proof. Consider the action of conjugating each of the 16 possible two-qubit Pauli strings over qubits i and j with ∧X gates, with the control on qubit i and the target on qubit j. The set of strings for which this action diagonalises qubit j is D:={II, IZ, XX, XY, YX, YY, ZI, ZZ}. By inspection, σᵢₗ∈{Z, I}⇔σⱼₗ∈{Z, I}, ∀l∈{1, . . . ,8}. The application of single-qubit Clifford gates is capable of permuting the Paulis on each qubit independently, but a corresponding relation must still be satisfied for whichever Pauli permutation the single-qubit Clifford gates have generated (as per Equation 9).

The Theorem 5.1 determines the single-qubit Clifford gates required to convert to the basis in which conjugation by ∧X gates will diagonalise a qubit. Such a conversion is illustrated in FIG. 3, which provides an illustration of an application of the Theorem 5.1 to diagonalise a qubit. In FIG. 3a, there is shown an initial circuit, including a two-qubit chain, for which the Theorem 5.1 is satisfied by A=Y and B=Y. Therefore, V and V^{\} gates are converted to a correct basis such that A=Z and B=Z, as shown in FIG. 3b. It is then feasible to choose which qubit to diagonalise. Arbitrarily, a second Qubit can be selected, and conjugated with required ∧X gates as shown in FIG. 3c, wherein the second qubit is shown comprising a sequence of phase gadgets. Applying the Theorem 5.1 to appropriate two-qubit chains is a subroutine in methods of the present disclosure to diagonalise arbitrary adjacent commuting Pauli gadgets, as also illustrated in FIG. 4 as described below.

5.1.2 Diagonalisation Algorithm

Pseudo-code for the diagonalisation method disclosed herein is presented in FIG. 4. This diagonalisation method comprises three functions, of which a third function represents a main routine. This main routine first calls an update single qubits subroutine, namely a first function in FIG. 4, which corresponds to a step (i) in the algorithm below. The main routine then calls an update pairs of qubits subroutine, namely a second function in FIG. 4, which corresponds to a step (ii) in the algorithm below. The main routine then calls a greedy diagonalisation subroutine, which corresponds to a step (iii) in the algorithm below; the implementation of this subroutine is readily apparent to a person of ordinary technical skill and is omitted from FIG. 4.

The overall time complexity for this algorithm including the steps (i) to (iii) below is [symbol] (mn³), with m being a number of Pauli gadgets in a commuting set and n being a number of qubits. FIGS. 5 and 6, wherein FIG. 6 is a continuation of FIG. 5, provide an illustration of this method applied to an example set, as shown in FIG. 5a, having 5 qubits. The strings in this mutually commuting set are: IXZIZ, IYIZY, XXIYI, YYXII, ZIYXX, ZXIZZ, and ZYZIY. The method comprises the following three steps of operations:
(i) Checking whether or not there is a trivially diagonalisable qubit: that is, a qubit i for which ∃P∈{X, Y, Z} s.t. ∀l, σᵢₗ∈{I,P}. Any such qubits may be diagonalised with only single-qubit Clifford gates, and ignored for the subsequent steps. This check takes time [symbol] (mn). The example set of FIG. 5a contains no such qubits.
(ii) Searching for a pair of qubits that satisfy the Theorem 5.1 for any choice of Paulis A and B. Such a search can be performed in [symbol] (mn²). If such a pair of qubits is found, there is performed the diagonalisation as specified in the Theorem 5.1 above. By way of example, there is no valid choice of A and B for any pair of qubits in the example set of FIG. 5a.
(iii) Adopting a greedy approach as a backup strategy, if the search is unsuccessful. In [symbol] (m), there is implemented finding the Pauli string with a lowest weight; if there are multiple such Pauli strings, there is implemented picking one Pauli string arbitrarily. There is also implemented conjugating the corresponding Pauli gadget with a single-qubit Clifford gate and ∧X gates to convert the Pauli string to II . . . IZ, as illustrated in FIG. 5b. Then, there is implemented commuting of the Clifford gates through the rest of the gadgets, as shown in FIG. 5c, until all Clifford gates are outside the adjacent Pauli gadgets. Every gadget must still commute with the IIIIZ string, and therefore the last qubit must be diagonal.

The steps (i) through (iii) are repeated (namely, are iterated) until all qubits are diagonal over the set of Pauli gadgets. Following an example provided in FIG. 5, it is found that FIG. 5c has the same two-qubit chain on the first and second qubits as our example from FIG. 3a, and can therefore be diagonalised in the same way. This diagonalisation results in the quantum circuit in FIG. 6a. A backup strategy of the step (iii) is not required for the remaining qubits; these remaining qubits can be diagonalised using the steps (i) and (ii) above to produce the quantum circuit shown in FIG. 6b after full diagonalisation has been performed. However, in a case where trivially diagonalisable qubits cannot be found, n repetitions of the steps (i) through (iii) are performed, so the method shown by the pseudo-code of FIG. 4 has a time complexity [symbol] (mn³). If such a greedy approach of the step (iii) has to be repeatedly performed, namely because trivially diagonalisable qubits cannot be found, the Clifford Circuit (C) will require [symbol] (n²) ∧X gates for its implementation. If an application of the Theorem 5.1 can be found for each iteration, in other words the step (iii) above is not used for any iteration, then C will require at most n-1 ∧X gates. For a small example set in FIG. 5A, where m=7 and with n=5 and where the step (iii) was used in a first iteration, C was found to use 5 ∧X gates only.

5.2 Phase Polynomials

After diagonalisation, the interior section for each set is comprised entirely of phase gadgets corresponding to S′ in FIG. 7. A corresponding phase gadget circuit can be expressed as a phase polynomial [9]. Phase polynomials have been used for circuit optimisation [32, 30, 9, 4], and a representation of phase gadget circuits as phase polynomials has also led to circuit optimisation techniques [11].

For describing phase polynomials, D denotes a quantum circuit containing only ∧X gates and gates Rz(θ₁), Rz(θ₂), . . . , Rz(θₘ). An action of D on a basis state |x₁, x₂ . . . xₙ [symbol] has a form as defined in Equation 10 (Eq. 10):

D|x₁,x₂. . . xₙ [symbol] =e^{ip(x}^{₁}^{,x}^{₂}^{, . . . x}^{ₙ}⁾|h(x₁,x₂, . . . ,xₙ) [symbol] Eq.10

where state h(x₁, x₂ . . . xₙ) is a linear reversible function, expressed in Equation 11 (Eq. 11):

$$p ( {x}_{1} , {x}_{2} , … , {x}_{n} ) = {\sum }_{i = 1}^{m} {θ}_{i} {f}_{i} ( {x}_{1} , {x}_{2} , … , {x}_{n} ) \qquad Eq . 11$$

wherein Equation 11 is a linear combination of affine Boolean functions fᵢ: {0,1}ⁿ→{0,1}. The phase polynomial of the circuit D is a function p(x₁, x₂ . . . xₙ). For a further description, see Nam et al. [32].

FIGS. 7A and 7B are illustrations of examples of mappings between phase gadgets and quantum circuits using phase polynomials. The quantum circuit in FIG. 7A is equivalent to a phase gadget over two qubits. Such mappings generalise in that any phase gadget over n qubits is equivalent to a phase polynomial with one term, as illustrated in FIG. 7B. For all phase gadget circuits, the linear reversible function h is an identity.

The phase polynomials described herein are therefore synthesised into a quantum circuit having ∧X gates and Rz(θ) gates with a low ∧X gates overhead using a heuristic from Amy et al. [7]. Optimal synthesis of phase polynomials into ∧X gates has been found to be NP-complete in specific cases, but the time complexity of finding the optimal ∧X gate count in the general case is unproven.

In embodiments of the present disclosure, there is used a so-called ‘GraySynth’ heuristic from Amy et al. [7] to find subsets of p(x₁,x₂ . . . xₙ) that can be efficiently iterated with a fixed target qubit. Such a GraySynth procedure runs in a time [symbol] (mn³), and requires a maximum of [symbol] (mn) ∧X gates when the linear reversible function h is an identity [6], as is the case for the approach described herein. The implementation in Amy et al. reduced the ∧X gate count by 23% across a suite of Clifford+T benchmark circuits, with a maximum reduction of 43%.

The circuit transformations described above in aforesaid sections 3.1 and 5.1 of the present disclosure enable partitioning of a given circuit into large phase polynomials divided by regions of Clifford circuits, thereby allowing the GraySynth algorithm to synthesise these phase polynomials with low ∧X overhead. The synthesised circuit generated from the interior phase gadgets for the example set of FIG. 5a is shown in FIG. 6c. Through naive decomposition, this initial set from FIG. 5a would require 34 ∧X gates, and 34 ∧X depth. The compilation approach described herein allows the ∧X count to be reduced to 22 and the ∧X depth to 18; such reductions provide important technical benefits of less computation noise and faster quantum computation.

5.3 Clifford Peephole Optimisation

When Clifford Peephole Optimization is used in methods pursuant to the present disclosure, namely after using the aforesaid phase polynomial formalism, the Ansatz circuit is in a form with layers of Clifford operations between {∧X, Rz}circuits. Referring back to Equation 8 (Eq. 8), the Clifford gates C (and C^{\}) may be directly implemented, while the phase polynomial formalism has provided a synthesis for S′. Although such an Ansatz circuit could be used at this stage, an additional procedure is optionally performed, if desired, to reduce further the ∧X count.

Apart from a basic cancellation of adjoint gates between Clifford layers, it is also optionally possible to perform peephole optimisation by finding small patterns of two-qubit Clifford circuits and replacing them with equivalent circuits with lower ∧X counts. Such processing is illustrated in FIG. 8, in which certain Clifford identities are recognised and applied to reduce the ∧X count [19]. In FIG. 8, a S gate corresponds to

$$R z ( \frac{π}{2} )$$

and a V gate corresponds to

$$R x ( \frac{π}{2} ) ) .$$

A single sweep of such an optimisation can be performed in period of [symbol] (dn²), where d is the circuit depth. It well be appreciated that performing associated rewrite rules potentially generates more instances where they can be applied, namely the replacement equivalent circuits with lower ∧X counts potentially themselves lead to further patterns which can be replaced by equivalent circuits with lower ∧X counts. Accordingly, an iterative approach is optionally used, in which the rewrite rules are re-applied until no more suitable patterns can be found, and/or until a chosen number of sweeps, namely iterations, have been applied, for example to suit a specified compilation time.

Pattern-matching and rewriting of the Clifford peephole optimisation is optionally performed using a directed acyclic graph (DAG), with vertices representing gates and edges representing qubits. Ports track an order of incident edges to a vertex in order to represent non-commutative operations such as an ∧X gate. Such graph rewriting to perform peephole optimisation for quantum circuits is described in general terms in publications [4, 32, 17], and has been performed for Clifford circuits in particular by Kliuchnikov and Maslov [25]. This final step of the compilation process of the present disclosure is beneficially considered to be an optional ‘clean-up’ step.

In Table 1, there is provided a summary of relevant complexities of mutually different subroutines in an overall compilation strategy described herein, in which m is a total number of Pauli exponentials, d is a depth of a quantum circuit to be generated, and n is a number of qubits to be used in the quantum circuit. Time complexity refers to a compilation time taken for such a strategy, while ∧X complexity is defined as being a maximum number of ∧X gates required for a circuit synthesis for the quantum circuit. It will be appreciated that graph colouring and Clifford rewriting do not perform circuit synthesis and therefore do not have an associated ∧X complexity.

TABLE 1

| | Time complexity | ΛX complexity |
|---|---|---|
| Graph colouring | [symbol] (m²n) | — |
| Diagonalisation | [symbol] (mn³) | [symbol] (n²) |
| GraySynth [7, 6] | [symbol] (mn³) | [symbol] (mn) |
| Clifford Rewriting | [symbol] (dn²) | — |

### 6. Results

The compilation strategy described as aforementioned has been implemented in a retargetable compiler t|ket [symbol] (trade mark “t|ket [symbol] ” is protected by Cambridge Quantum Computing Ltd.) to benchmark methods and approaches of the present invention on a suite of Ansatz circuits for solving VQE problems relating to various computation tasks, for example for simulating an electronic structure of molecules, to system optimization tasks, to signal processing tasks (for example, signal noise reduction in bioinformatics, for example when processing PCR read data from Illumina Inc. or Qiagen Inc. DNA readout machines), to quantum natural language processing (for example, when used in voice recognition apparatus), to quantum machine learning, but not limited thereto. This benchmarking, for simulating the electronic structure of molecules included the molecules H₂, H₄, H₈, LiH, NH, H₂O, CH₂, NH₃, HNO, H₂CO and CO₂ in the ‘sto-3g’ basis sets ([105]); the benchmarking demonstrates that approaches and methods of the present disclosure can be made to function effectively in practice. For the smaller molecules, it is advantageous also to use ‘631g’ and ‘ccpvdz’ bases ([105]). Testing of embodiments of the present disclosure was also performed across the Bravyi-Kitaev (BK), Jordan-Wigner (J W) and Parity (P) encodings referred to above.

The aforesaid benchmarking comparisons made are between:
1. Naive decomposition: a quantum circuit generated by iterating through a list of Pauli exponentials given by naive Trotterization of the excitation operators and converting each Pauli exponential individually into ∧X ladders (patterns of ∧X gates extending in the depth direction of the quantum circuit).
2. Templated lexicographical operator sequence (TLOS): for Ansatz circuits generated using the JW encoding, a comparison is beneficially made against a simple implementation of the best-known previous strategy for JW circuit synthesis: operator sequencing methods from Hastings et al. [21] with templated excitation operators from Nam et al. [3]. Such qubit resources are scarce and do not allow the use of ancillae for this comparison; Hastings et al. showed that using of ancillae is susceptible to reduce ∧X overhead significantly. There is a lack of similar strategies for the BK or P encoding.
3. Pairwise synthesis: a quantum circuit generated by graph colouring and then synthesising Pauli gadgets within a set in a pairwise manner using the methods from Cowtan et al. [17].
4. Set synthesis: a full compilation strategy—graph colouring, diagonalisation, phase polynomial synthesis and Clifford peephole rewriting as per implementations, approaches and methods of the present disclosure.

In devising embodiments of the present disclosure, circuits in the test set used for the aforesaid comparison were chosen to have a ∧X count and depth of less than 10⁶ when decomposed naively. All results were obtained using a machine with a 2.3 GHz Intel Core i5 processor and 8 GB of 2133 MHz LPDDR3 memory running MacOS Mojave v10.14. A comparison of ∧X metrics for different compilation strategies for molecules with varying active spin orbitals and using different qubit encoding methods is shown in FIG. 9. It will be appreciated that FIG. 9 is split across three sheets as FIGS. 9A, 9B and 9C representing the BK, JW and P qubit encoding, respectively. The naïve decomposition (1) is labelled as “no colouring” in FIG. 9 and a 4th-degree polynomial least-squares fit has been added to the plots to suggest scaling. It can be seen that the set-based synthesis strategy (4) as disclosed herein outperforms pairwise (3) and naive (1) on all encodings, and performs approximately equally with the TLOS method (2) for the JW encoding.

TABLE 2

| | Qubit | | |
|---|---|---|---|
| | Encoding | Mean ΛX count | Mean ΛX depth |
| | Method | reduction (%) | reduction (%) |
| Pairwise Synthesis | BK | 48.2 | 60.0 |
| Set-based Synthesis | BK | 65.5 | 73.2 |
| Pairwise Synthesis | JW | 66.4 | 72.2 |
| Set-based Synthesis | JW | 81.3 | 84.6 |
| TLOS Synthesis | JW | 81.6 | 84.0 |
| Pairwise Synthesis | P | 46.2 | 59.8 |
| Set-based Synthesis | P | 68.2 | 75.3 |
| Pairwise Synthesis | All | 53.6 | 64.0 |
| Set-based Synthesis | All | 71.8 | 77.5 |

Set-based synthesis gives greater fractional reductions for larger circuits than for smaller ones. For the largest circuits, a reduction of up to 89% in ∧X depth has been achieved, compared to the mean average reduction in ∧X depth of 77.5% as presented in Table 2.

It will be appreciated that the compilation strategy described herein generally assumes the qubits have all-to-all connectivity; in other words, ∧X gates are allowed between any two qubits. Some hardware implementations of a quantum computer optionally constrain such connectivity; in this case, appropriate routing is beneficially utilised to help a circuit conform to the constraints, as elucidated in greater detail below.

### 7. Discussion

Approaches, methods and strategies of the present disclosure described herein represent an empirically successful synthesis of a given UCC Ansatz into one- and two-qubit gates. This synthesis has been shown in practice to achieve large average reductions in ∧X metrics for the Bravyi-Kitaev and Parity qubit encodings, and to match an existing strategy for the Jordan-Wigner encoding. It is emphasised that the approach described herein is not limited to these three qubit encodings, but rather are susceptible to being utilised for any other qubit encodings which generate similar Trotterized excitation operators. Furthermore, although the present approaches, methods and strategies have been described herein in a context of synthesising of a UCC Ansatz, such synthesis is susceptible to being utilised in other situations and contexts, as described in greater detail below.

7.1 Applications for Measurement Reduction

Measurement reduction for VQE is a method for simultaneously measuring terms in a Hamiltonian which commute and thereby reducing a number of circuits required to run VQE [22, 18, 40]. For realistic devices, assuming that only available native measurements are single-qubit Z-basis measurements, generating a Clifford circuit to diagonalise this set of measurements is required. Reducing, for example minimising, a complexity of this Clifford circuit using the aforesaid Theorem 5.1 as presented above is capable of reducing the ∧X overhead required for such a measurement reduction.

7.2 Architecture-Aware Synthesis

Instead of introducing a SWAP network to enforce connectivity constraints on noisy intermediate-scale quantum (NISQ) devices, recent work has explored the possibility of resynthesising a circuit in a topologically aware manner for limited gate sets [23, 33, 39]. This constrained synthesis has been found typically to produce lower ∧X counts than SWAP networks, and phase polynomials are a viable class of circuit for constrained synthesis [8]. If topologically constrained phase polynomials can be composed with Clifford regions in a manner that respects architecture, this would appear to be a promising strategy for those devices with limited connectivity and is susceptible to being used in embodiments of the present disclosure.

7.3 Applications to Fault Tolerant Computation

Although the approaches, methods and strategies described herein have been implemented for VQE in embodiments of the present disclosure, these are susceptible to being directly ported over to nonvariational quantum algorithms for Hamiltonian dynamics which require gate counts and qubit numbers that are too high for noisy intermediate-scale quantum (NISQ) computers. Recent work by Gui et al. [20] has performed term sequencing for quantum evolution defined by a time-dependent Hamiltonian which is mapped to a quantum circuit. Reducing Trotter error is more important for fault-tolerant algorithms than for VQE, and Gui et al. argue term sequencing, such as performed in the present application, would help to reduce, for example minimise, Trotter error.

The compilation strategy proposed herein pursuant to the present disclosure is primarily intended to reduce two-qubit gate count and depth; however, these parameters are not considered to be as expensive on planned fault tolerant devices as magic states, since the ∧X gate can be performed without distillation. However, work by Litinski [28] shows that on surface code-based computers, performing a two-qubit gate is potentially as costly in the worst case as magic state distillation, hence two-qubit gate reduction would still represent a valuable optimisation.

Moreover, the quantum circuits produced by the compilation strategy disclosed herein pursuant to the present disclosure have a structure such that all non-Clifford gates reside in partitioned phase polynomials. T-count and depth optimisation are susceptible to being successfully performed using the phase polynomial formalism via matroid partitioning [9], with benchmarks showing up to 65.7% T-count reduction and 87.6% T-depth reduction without ancillae, and up to 99.7% T-depth reduction using (with) ancillae. The parities of non-Clifford rotations in a phase polynomial generated via diagonalisation are beneficially all different, and therefore the T-counts cannot be optimised using phase-folding; nevertheless, T-depth reductions are still susceptible to being achieved using the compilation strategy described herein pursuant to the present disclosure.

General

FIG. 10 is a flowchart providing an illustration of steps of an example method in accordance with the approach described herein. This method is generally implemented by a compiler used to generate a quantum circuit for use in a quantum computer. The method commences with receiving as input the UCC Ansatz at an operation 110. The UCC Ansatz, which is a known entity, includes, inter alia, Pauli strings corresponding to, namely that are derived from, excitation operators for a Hamiltonian that describes a physical quantum system. For example, the UCC Ansatz is commonly used to simulate molecular systems, such as to determine a ground state and a configuration for such a molecular system, and associated excitation operators reflect physical properties of the molecular system which is being simulated. However, it will be appreciated that the UCC Ansatz can be used to represent other types of systems, for example complex networks, nuclear reactions occurring in molten salt reactors, fluid flows within heat exchangers, energy states in laser devices and so forth. Moreover, results derived from the USS Ansatz can be used for complex real-time control systems.

At an operation 120, the Pauli strings from the UCC Ansatz are partitioned into sets, such that all the Pauli strings in a given set are required to commute with one another under multiplication. Conversely, Pauli strings that are partitioned into different sets are not required to commute with each other under multiplication. Each Pauli string from the UCC Ansatz is allocated, namely is partitioned, into a single set. The objective is to have as few sets as possible, which also implies that the sets are generally large to accommodate all the Pauli strings from the UCC Ansatz. A graph colouring algorithm, for example as described in the foregoing, is beneficially used to find a partitioning solution which satisfies, exactly or approximately, this objective of having as few sets as possible.

At an operation 130, the Pauli strings are sequenced by set; in other words, all the Pauli strings in a given set are contiguous with one another in their sequencing.

An arbitrary ordering is optionally used for the Pauli strings within any given set, and also between the different sets.

At an operation 140, Trotterization is used to generate a sequence of Pauli gadgets from the partitioned Pauli strings, such that Pauli gadgets that derive from Pauli strings in a given set are likewise grouped contiguously. The Trotterization provides an approximation of the Hamiltonian based on the Pauli gadgets to facilitate further analysis.

The sequence of Pauli gadgets from the operation 140 is beneficially used directly to provide a potential quantum circuit implementation of the UCC Ansatz; however, such a quantum circuit is potentially relatively complex. Therefore, at an operation 150, a Clifford circuit is determined to diagonalise each set of Pauli gadgets into a corresponding set of phase gadgets. Phase gadgets are a subset of Pauli gadgets having a diagonalised form, which in turn helps to achieve a more compact and efficient quantum circuit implementation of the UCC Ansatz.

Accordingly, in the operation 150, a set of Pauli gadgets from the operation 140 is equated to an expression comprising three components:
(i) a Clifford circuit;
(ii) a set of phase gadgets, and
(iii) an inverse Clifford circuit. It will be appreciated that an inversion is not the same as a conjugation. In this context, an operation A is conjugated by another B using B⁻¹ A B (or B A B⁻¹), so the phase gadgets are conjugated by the Clifford circuit (and its inverse), hence “conjugating” is to be understood to mean “mapped into a different basis by”.

The Clifford circuits in effect transform between an original basis of the Pauli gadgets and a new basis in which the Pauli gadgets are phase gadgets. Although the Clifford circuits used to these basis changes represent additional overhead, namely additional quantum gates in a resulting quantum circuit, this cost is outweighed by the savings in quantum gates arising from the use of phase gadgets rather than the more general Pauli gadgets.

It will be appreciated that the diagonalisation is performed separately on each set of Pauli gadgets. The larger the set, namely the more Pauli gadgets it contains, the greater the saving that is typically achieved as a result of converting the Pauli gadgets to phase gadgets pursuant to methods, approaches and strategies of the present disclosure; hence, there arises a motivation to find large sets in partitioning of the operation 120. It will be appreciated that, although the implementation pursuant to the present disclosure uses Clifford circuits for the diagonalisation from Pauli gadgets to phase gadgets, other techniques for performing such a diagonalisation are also susceptible to being implemented.

Once the sequence of Clifford circuits and phase gadgets has been determined at the operation 150, the sequence of diagonalised phase gadgets is then converted into native gates at an operation 160 using the aforesaid phase polynomial formalism; optionally, instead of using the aforesaid phase polynomial formalism, other suitable techniques for synthesizing native gates from phase gadgets are used. In addition, the Clifford circuits are susceptible to being simplified in an operation 170 using a technique such as aforesaid peephole optimisation. It will be appreciated that this optimisation of the operation 170 is optional and may be omitted in some implementations. Furthermore, the ordering of the operations 160 and 170 is optionally altered if desired, for example so that the operation 170 is performed before or concurrently with the operation 160.

An outcome of the processing operations of FIG. 10 is that a quantum circuit is synthesized to represent the received UCC Ansatz, and this quantum circuit is then susceptible to being implemented on a quantum computer to simulate the physical system, for example molecular system, represented by the UCC Ansatz. The quantum computer is then susceptible to providing a simulation of the UCC Ansatz at a very great computational speed in comparison to computational speeds of conventional computers, wherein the simulation can be used, for example, to control a real physical system from which the USS Ansatz is derived. In other words, the quantum computer can be used as a part of a feedback control arrangement to provide real-time feedback control of a complex system.

Although approaches, methods and strategies for generating quantum circuits are described in the foregoing, the present disclosure also relates to apparatus and systems that are configured to implement the approaches, methods and strategies. Referring to FIG. 11, there is shown a schematic diagram of a computing system for implementing the approaches, methods and strategies described herein. The computing system includes a quantum computer 250 and a classical non-quantum computer 210. It will be appreciated for purposes of clarity that standard internal hardware and software components of classical computer 210, such as a processor, memory, storage, input/output, communications, operating system and so on that are not directly relevant to an understanding of the approach described herein are omitted from FIG. 11. Likewise, standard internal components of quantum computer are generally omitted from FIG. 11, with the exception of qubits 255. Optionally, the quantum computer 250 is based on one or more of:
(i) superconducting semiconducting quantum gates that are cooled, when in operation, to substantially absolute zero temperature (namely circa −273° C.);
(ii) ion trap devices functioning as quantum gates, wherein a trapped ion is representative of a state of a qubit, wherein the trapped ion is manipulated by using electrostatic and/or magnetic fields; and
(iii) photonic quantum gates, wherein individual photons function as qubits.

A UCC Ansatz 215 is created or loaded onto the classical non-quantum computer 210 where it serves as an input to a compiler 220. The compiler 220 is configured to implement the method of FIG. 10 to derive a quantum circuit 260 from the UCC Ansatz. As described above, a quantum circuit 260 is derived from this method, wherein the quantum circuit 260 is well-suited to the hardware characteristics of the quantum computer 250 by reducing ∧X counts, namely in respect of the number and depth of such gates, thereby helping, inter alia, to reduce noise and the susceptibility to decoherence in a corresponding quantum circuit generated from the UCC Ansatz 215.

In general, the compiler 220 generates the quantum circuit 260 on the classical computer 210 and the quantum circuit is then loaded onto the quantum computer 250 at run-time as part of the VQE system 225. In FIG. 11, the VQE system 225 is illustrated running on the same classical computer 210 as the compiler 220; in many implementations of the present disclosure, the compiler 220 will run on a first classical computer at compile time and the VQE system will run on a second classical computer at run time, wherein the first and second computers are mutually different. Optionally, alternatively, the first and second computer can be a same given classical computer. The VQE performs an iterative optimisation in which certain functionality within an iterative procedure, for example as described in the foregoing, is off-loaded from the classical computer 220 onto the quantum computer 250. In particular, each iteration of the optimisation calls the procedure implemented on the quantum computer 260 to perform a computation, and the iterations are repeated until an optimisation, for example minimisation, has been achieved. By way of example, each iteration may determine an energy for a quantum system given a set of one or more parameter values, and the optimisation seeks to identify the set of parameter values that produce a lowest energy for the system, wherein this lowest energy then corresponds to a ground state.

As described herein in the present disclosure, a system and method are provided for generating a quantum circuit. The method is typically implemented by running the compiler 220, whereby the compiler 220 is a computer program comprising program instructions that, when executed on a computing device, causes the computing device to perform such a method. The compiler may be provided on a suitable storage medium such as described below for loading into the memory for execution by a processor. The system is typically implemented by a combination of the compiler 220 and the computer 210 and hence may represent a combination of hardware and software. The hardware, namely an apparatus or machine, optionally comprises a standard, general-purpose computing device, or in some implementations, the hardware, namely computing device or system, optionally includes more specialised components, for example array processors. The software generally comprises the compiler 220 and an environment (operating system etc.) for running the compiler 220. The program instructions of the compiler 220 are typically loaded into memory of the computer 210 for execution by one or more processors to cause the computer 210 to perform the method of FIG. 10. The computer program is susceptible to being stored in a non-transitory medium prior to loading into memory, for example, on flash memory, a hard disk drive, and so forth.

The approaches, methods and strategies described herein optionally include three main steps, as follows:
(1) performing a macroscopic term sequencing for a quantum circuit using Pauli strings. This sequencing is equivalent to a known problem in graph theory referred to as being a “colouring problem”. A popular greedy algorithm is beneficially used to approximate a solution to this problem ([116], [20]). Moreover, this term sequencing supports the following two steps:
(2) converting the Pauli strings into phase gadgets. This conversion is referred to as being “diagonalisation” [22]; and
(3) converting the phase gadgets into quantum gates which can be run natively on a quantum computer using an aforesaid phase polynomial formalism [9]. This conversion can be performed efficiently using a heuristic known as “GraySynth'” [7].

Unlike many previous compilation strategies for chemistry circuits, the present approach of the present disclosure is agnostic to many technical problem specifics, such as qubit encoding, basis set and molecule of choice. The approaches, methods and strategies of the present disclosure provide a generic compilation strategy for the UCC Ansatz.

Indeed, the present compilation strategy may be utilised beyond one or more UCC Ansätze (it will be appreciated that “Ansätze” is a plural of “Ansatz”). It will be appreciated that scientists often make an Ansatz, namely an educated guess, and then proceed to compute the consequences of the guess. An Ansatz translates a provisional mathematical assumption used to describe a certain phenomenon, for example a molecule, a technical functioning system and so forth. One example of such a further application is for QAOA (Quantum Approximate Optimization Algorithm), see [109]. This application is also based on a Trotterized Hamiltonian as for the UCC Ansatz, and is used for other types of tasks including, at least in part, general combinatorial optimisation problems; examples of such general combinatorial optimisation problems include supply-line optimization related to the travelling salesman problem, and register allocation & job scheduling ([110]).

Other potential applications of a quantum circuit such as generated herein include for the performance of machine computations relating (without limitation)_to one or more of the following: system optimization, variational inference, signal filtering, genetic data processing to find phenotypes and associated single nucleotide polymorphisms (SNP's), supply-line optimization problems, register allocation problems in computing hardware, job scheduling problems, solid state physics, condensed matter physics, quantum optics, nuclear and/or particle physics, artificial intelligence (AI), neural networks, natural language processing (NLP), cryptography and/or quantum systems having a Hamiltonian which is subject to Trotterization, such as for determining molecular structure or quantum evolution (where the Hamiltonian may represent an energy of the quantum system). The quantum circuit may also be used in other areas of machine computation as apparent to the skilled person.

As noted above, such machine computations may be performed on the same computer system(s) used for generating the quantum circuit, or on a separate computer system. It will be understood that the generation of a quantum circuit is typically performed on a classical computer system, while the resulting quantum circuit is intended for implementation in a computer system that includes a quantum computer.

The present application has described the use of the UCC Ansatz to help investigate molecular structure. The choice of ansatz determines what portion of the Hilbert space can be accessed to find a solution and how the solution is parameterised. The UCC Ansatz is useful in chemistry because it is known that chemicals already have a particular structure, and the desired solution will lie in or close to the subspace of the Hilbert space which is accessible by the UCC Ansatz, and the resulting parameterisation has semantic meaning. The UCC Ansatz could potentially be used in other technical areas, such as for NLP or AI as aforementioned. In these areas, the representation in the Hilbert space and the interpretation of the parameters are not significant per se. The use of the UCC Ansatz in such a context would impose a structure on a system to be modelled/optimised (which might be beneficial or harmful), rather than using prior knowledge of the structure of the system. More generally, an NLP or AI Ansatz does not require a specific form because, in these applications, it is not known what the representation of abstract mathematical concepts should look like, rather there is a motivation to try to uncover the structure of a corpus/data collection.

In some example implementations, a method or system may be used to monitor a time evolution of states of quantum circuits during quantum computations. However, observing a state in the middle of quantum circuit operations will generally alter the state/computation. Accordingly, a compiler such as described herein is generally more intent on preserving global semantics of a circuit (namely, the relationship between the initial state and the corresponding final state after applying the circuit), but without making any guarantee about intermediate states. If there are only a few points in a circuit where a user wishes to preserve an intermediate state, one or more barriers can be inserted into the circuit at those points, for example a plurality of barriers can be inserted into the circuit. Such barriers may be treated as identity operations, but any rewrite made by the compiler must be either entirely before or entirely after a given barrier, thus preserving the state at that point of the given barrier in the circuit.

In conclusion, various implementations and examples have been disclosed herein. It will be appreciated that these implementations and examples are not intended to be exhaustive, and the skilled person will be aware of many potential variations and modifications of these implementations and examples that fall within the scope of the present disclosure. It will also be understood that features of particular implementations and examples can typically be incorporated into other implementations and examples, unless the context clearly indicates to the contrary. In summary, the various implementations and examples herein are disclosed by way of illustration rather than limitation, and the scope of the present invention is defined in the appended claims.

### REFERENCES

[1] Networkx Greedy Color. Available at https://networkx.github.io/documentation/stable/reference/algorithms/generated/networkx.algorithms.coloring.greedy_color.html
[2] S. Aaronson & D Gottesman (2004): Improved Simulation of Stabilizer Circuits. Phys. Rev. A 70(052328), doi:10.1103/PhysRevA.70.052328.
[3] Yunseong Nam et al. (2019): Ground-state energy estimation of the water molecule on a trapped ionquantum computer. arXiv.org.
[4] M. Amy, D. Maslov, M. Mosca & M. Roetteler (2013): A Meet-in-the-Middle Algorithm for Fast Synthesis of Depth-Optimal Quantum Circuits. IEEE Transactions on Computer-Aided Design of Integrated Circuits and Systems 32 (6), pp. 818-830, doi:10.1109/tcad.2013.2244643. Available at http://dx.doi.org/10.1109/tcad.2013.2244643.
[5] Reference not used.
[6] Matthew Amy (2020): Personal correspondence.
[7] Matthew Amy, Parsiad Azimzadeh & Michele Mosca (2018): On the controlled-NOT complexity of controlled-NOT-phase circuits. Quantum Science and Technology 4(1), p. 015002, doi:10.1088/2058-9565/aad8ca.
[8] Matthew Amy & Vlad Gheorghiu (2019): staq —A full-stack quantum processing toolkit. arXiv.org.
[9] Matthew Amy, Dmitri Maslov & Michele Mosca (2014): Polynomial-Time T-Depth Optimization of Clifford+T Circuits Via Matroid Partitioning. IEEE Transactions on Computer-Aided Design of Integrated Circuits and Systems 33 (10), pp. 1476-1489, doi:10.1109/TCAD.2014.2341953.
[10] Frank Arute, Kunal Arya, Ryan Babbush, Dave Bacon, Joseph C. Bardin, Rami Barends, Rupak Biswas, Sergio Boixo, Fernando G. S. L. Brandao, David A. Buell, Brian Burkett, Yu Chen, Zijun Chen, Ben Chiaro, Roberto Collins, William Courtney, Andrew Dunsworth, Edward Farhi, Brooks Foxen, Austin Fowler, Craig Gidney, Marissa Giustina, Rob Graff, Keith Guerin, Steve Habegger, Matthew P. Harrigan, Michael J. Hartmann, Alan Ho, Markus Hoffmann, Trent Huang, Travis S. Humble, Sergei V. Isakov, Evan Jeffrey, Zhang Jiang, Dvir Kafri, Kostyantyn Kechedzhi, Julian Kelly, Paul V. Klimov, Sergey Knysh, Alexander Korotkov, Fedor Kostritsa, David Landhuis, Mike Lindmark, Erik Lucero, Dmitry Lyakh, Salvatore Mandrà, Jarrod R. McClean, Matthew McEwen, Anthony Megrant, Xiao Mi, Kristel Michielsen, Masoud Mohseni, Josh Mutus, Ofer Naaman, Matthew Neeley, Charles Neill, Murphy Yuezhen Niu, Eric Ostby, Andre Petukhov, John C. Platt, Chris Quintana, Eleanor G. Rieffel, Pedram Roushan, Nicholas C. Rubin, Daniel Sank, Kevin J. Satzinger, Vadim Smelyanskiy, Kevin J. Sung, Matthew D. Trevithick, Amit Vainsencher, Benjamin Villalonga, Theodore White, Z. Jamie Yao, Ping Yeh, Adam Zalcman, Hartmut Neven & John M. Martinis (2019): Quantum supremacy using a programmable superconducting processor. Nature 574(7779), pp. 505-510, doi:10.1038/s41586-019-1666-5.
[11] Niel de Beaudrap, Xiaoning Bian & Quanlong Wang (2019): Techniques to reduce_/4-parity phase circuits, motivated by the ZX calculus. arXiv.org.
[12] Andrew M. Childs, Eddie Schoute & Cem M. Unsal (2019): Circuit Transformations for Quantum Architectures. In Wim van Dam & Laura Mancinska, editors: 14th Conference on the Theory of Quantum Computation, Communication and Cryptography (TQC 2019), Leibniz International Proceedings in Informatics (LIPIcs) 135, pp. 3:1-3:24, doi:10.4230/LIPIcs.TQC.2019.3. Available at http://drops.dagstuhl.de/opus/volltexte/2019/10395.
[13] Andrew M. Childs, Yuan Su, Minh C. Tran, Nathan Wiebe & Shuchen Zhu (2019): A Theory of Trotter Error. arXiv.org.
[14] Bob Coecke & Ross Duncan (2011): Interacting Quantum Observables: Categorical Algebra and Diagrammatics. New J. Phys 13(043016), doi:10.1088/1367-2630/13/4/043016. Available at http://iopscience.iop.org/1367-2630/13/4/043016/.
[15] Bob Coecke & Aleks Kissinger (2017): Picturing Quantum Processes: A First Course in Quantum Theory and Diagrammatic Reasoning. Cambridge University Press.
[16] Alexander Cowtan, Silas Dilkes, Ross Duncan, Alexandre Krajenbrink, Will Simmons & Seyon Sivarajah (2019): On the qubit routing problem. In Wim van Dam & Laura Mancinska, editors: 14th Conference on the Theory of Quantum Computation, Communication and Cryptography (TQC 2019), Leibniz International Proceedings in Informatics (LIPIcs) 135, pp. 5:1-5:32, doi:10.4230/LIPIcs.TQC.2019.5. Available at http://drops.dagstuhl.de/opus/volltexte/2019/10397.
[17] Alexander Cowtan, Silas Dilkes, Ross Duncan, Will Simmons & Seyon Sivarajah (2019): Phase Gadget Synthesis for Shallow Circuits. In: Proceedings of QPL2019 (to appear).
[18] Ophelia Crawford, Barnaby van Straaten, Daochen Wang, Thomas Parks, Earl Campbell & Stephen Brierley (2019): Efficient quantum measurement of Pauli operators. arXiv.org.
[19] Andrew Fagan & Ross Duncan (2019): Optimising Clifford Circuits with Quantomatic. In Peter Selinger & Giulio Chiribella, editors: Proceedings of the 15th International Conference on Quantum Physics and Logic, Halifax, Canada, 3-7th June 2018, Electronic Proceedings in Theoretical Computer Science 287, Open Publishing Association, pp. 85-105, doi:10.4204/EPTCS.287.5.
[20] Kaiwen Gui, Teague Tomesh, Pranav Gokhale, Yunong Shi, Frederic T. Chong, Margaret Martonosi & Martin Suchara (2020): Term Grouping and Travelling Salesperson for Digital Quantum Simulation. arXiv.org.
[21] Matthew B. Hastings, Dave Wecker, Bela Bauer & Matthias Troyer (2014): Improving Quantum Algorithms for Quantum Chemistry. Quantum Information and Computation 15.
[22] Andrew Jena, Scott Genin & Michele Mosca (2019): Pauli Partitioning with Respect to Gate Sets. arXiv.org.
[23] Aleks Kissinger & Arianne Meijer van de Griend (2020): CNOT circuit extraction for topologically constrained quantum memories. Quantum Information and Computation. To appear.
[24] Aleks Kissinger & John van de Wetering (2019): Reducing T-count with the ZX-calculus. arXiv.org.
[25] Vadym Kliuchnikov & Dmitri Maslov (2013): Optimization of Clifford circuits. Phys. Rev. A 88, p. 052307, doi:10.1103/PhysRevA.88.052307. Available at https://link.aps.org/doi/10.1103/PhysRevA.88.052307.
[26] Lingling Lao, Daniel M. Manzano, Hans van Someren, Imran Ashraf & Carmen G. Almudever (2019): Mapping of quantum circuits onto NISQ superconducting processors. arXiv.org.
[27] Joonho Lee, William J. Huggins, Martin Head-Gordon & K. Birgitta Whaley (2019): Generalized Unitary Coupled Cluster Wave functions for Quantum Computation. Journal of Chemical Theory and Computation 15(1), pp. 311-324, doi:10.1021/acs.jctc.8b01004. Available at https://doi.org/10.1021/acs.jctc.8b01004.
[28] Daniel Litinski (2019): Magic State Distillation: Not as Costly as You Think. Quantum 3, p. 205, doi:10.22331/q-2019-12-02-205. Available at http://dx.doi.org/10.22331/q-2019-12-02-205.
[29] Seth Lloyd (1996): Universal Quantum Simulators. Science 273(5278), pp. 1073-1078, doi:10.1126/science.273.5278.1073.
[30] Dmitri Maslov & Martin Roetteler (2017): Shorter stabilizer circuits via Bruhat decomposition and quantum circuit transformations. IEEE Transactions on Information Theory (7), pp. 4729-4738, doi:10.1109/TIT.2018.2825602.
[31] Jarrod R McClean, Jonathan Romero, Ryan Babbush & Alán Aspuru-Guzik (2016): The theory of variational hybrid quantum-classical algorithms. New Journal of Physics 18(2), p. 023023, doi:10.1088/1367-2630/18/2/023023. Available at http://stacks.iop.org/1367-2630/18/i=2/a=023023.
[32] Yunseong Nam, Neil J. Ross, Yuan Su, Andrew M. Childs & Dmitri Maslov (2018): Automated optimization of large quantum circuits with continuous parameters. npj Quantum Information 4(1), p. 23, doi:10.1038/s41534-018-0072-4. Available at https://doi.org/10.1038/s41534-018-0072-4.
[33] Beatrice Nash, Vlad Gheorghiu & Michele Mosca (2019): Quantum circuit optimizations for NISQ architectures. arXiv.org.
[34] John Preskill (2018): Quantum Computing in the NISQ era and beyond. Quantum 2, p. 79, doi:10.22331/q-2018-08-06-79. Available at https://doi.org/10.22331/q-2018-08-06-79.
[35] Jonathan Romero, Ryan Babbush, Jarrod R McClean, Cornelius Hempel, Peter J Love & Alán Aspuru-Guzik (2018): Strategies for quantum computing molecular energies using the unitary coupled cluster ansatz. Quantum Science and Technology 4(1), p. 014008, doi:10.1088/2058-9565/aad3e4. Available at https://iopscience.iop.org/article/10.1088/2058-9565/aad3e4.
[36] Mark Steudtner & Stephanie Wehner (2018): Fermion-to-qubit mappings with varying resource requirements for quantum simulation. New Journal of Physics 20(6), p. 063010, doi: 10.1088/1367-2630/aac54f. Available at https://iopscience.iop.org/article/10.1088/1367-263.
[37] Dave Wecker, Matthew B. Hastings & Matthias Troyer (2015): Progress towards practical quantum variational algorithms. Phys. Rev. A 92, p. 042303, doi:10.1103/PhysRevA.92.042303. Available at https://link.aps.org/doi/10.1103/PhysRevA.92.042303.
[38] K. Wright, K. M. Beck, S. Debnath, J. M. Amini, Y. Nam, N. Grzesiak, J. S. Chen, N. C. Pisenti, M. Chmielewski, C. Collins, K. M. Hudek, J. Mizrahi, J. D. Wong-Campos, S. Allen, J. Apisdorf, P. Solomon, M. Williams, A. M. Ducore, A. Blinov, S. M. Kreikemeier, V. Chaplin, M. Keesan, C. Monroe & J. Kim (2019): Benchmarking an 11-qubit quantum computer. Nature Communications 10(1), p. 5464, doi:10.1038/s41467-019-13534-2.
[39] Bujiao Wu, Xiaoyu He, Shuai Yang, Lifu Shou, Guojing Tian, Jialin Zhang & Xiaoming Sun (2019): Optimization of CNOT circuits on topological superconducting processors. arXiv.org.
[40] Andrew Zhao, Andrew Tranter, William M. Kirby, Shu Fay Ung, Akimasa Miyake & Peter Love (2019): Measurement reduction in variational quantum algorithms. arXiv.org.
[41] Alwin Zulehner, Alexandru Paler & Robert Wille (2017): An Efficient Methodology for Mapping Quantum Circuits to the IBM QX Architectures. arXiv.org.0/aac54f.
[101] https://quantaggle.com/algorithms/algorithm/ #VQE
[102] https://quantaggle.com/algorithms/ansatz/ #UCC
[103] https://cqcl.github.io/pytket/build/html/index.html
[104] https://en.wikipedia.org/wiki/Clifford_gates
[105] https://en.wikipedia.org/wiki/Basis_set_%28chemistry %29
[106] https://arxiv.org/pdf/1906.01734.pdf
[107] https://en.wikipedia.org/wiki/Pauli_matrices
[108] https://qiskit.org/
[109] https://arxiv.org/abs/1709.03489
[110] https://www.martincarlisle.com/publications/kcoloring.pdf
[111] https://arxiv.org/abs/1910.04735
[112] https://arxiv.org/abs/cond-mat/9510145
[113] https://www.cond-mat.de/events/correl16/manuscripts/scalettar.pdf
[114] http://aliramadhan.me/files/jaynes-cummings-model.pdf
[115] https://arxiv.org/abs/nucl-th/0308088
[116] https://networkx.github.io/documentation/stable/reference/algorithms/col oring.html
[117] https://arxiv.org/abs/1704.05018 Edward Farhi, Jeffrey Goldstone, Sam Gutmann, “A Quantum Approximate Optimization Algorithm Applied to a Bounded Occurrence Constraint Problem”, arXiv.org >quant-ph >arXiv:1412.6062v2

1. A computer-implemented method of generating a quantum circuit from a Unitary Coupled Cluster (UCC) Ansatz, wherein the Ansatz represents an excitation of a reference state by a parameterised operator including excitation operators, wherein the Ansatz includes multi-qubit Pauli operators that are determined from each excitation operator, and wherein the method comprises:
partitioning the Pauli operators into mutually commuting sets and sequencing the Pauli operators by set;
generating Pauli gadgets from the Pauli operators by Trotterization, wherein the Pauli gadgets have a same sequencing by set as the Pauli operators;
diagonalising each set of Pauli gadgets to convert the Pauli gadgets into phase gadgets; and
transforming the phase gadgets into one- and two-qubit native gates to generate the quantum circuit;
wherein the UCC Ansatz corresponds to a molecular structure.

2. A computer-implemented method of claim 1, wherein the method includes partitioning the Pauli operators into mutually commuting sets of operators to minimise a number of commuting sets required.

3. A computer-implemented method of claim 1, wherein the method includes partitioning the Pauli operators using a graph colouring algorithm.

4. A computer-implemented method of claim 1, wherein each set of Pauli gadgets is diagonalised using a Clifford circuit.

5. A computer-implemented method of claim 4, wherein each set of Pauli gadgets is represented as: (i) a Clifford circuit; (ii) a set of phase gadgets; and (iii) an inverse Clifford circuit.

6. A computer-implemented method of claim 5, wherein the Clifford circuit transforms between an original basis of the Pauli gadgets and a new basis in which the Pauli gadgets are represented by a corresponding set of phase gadgets.

7. A computer-implemented method of claim 4,
wherein for two qubits i and j, and S being a set of m mutually commuting Pauli gadgets and σₖₗ being a Pauli letter on qubit k from Pauli gadget l,
the qubit i or j is diagonalised by conjugating with at most one entangling gate and two single-qubit Clifford gates on each side of S between qubits i and j, subject to a proviso:
∃A,B∈{X,Y,Z}s.t.∀l∈{1, . . . ,m},σᵢₗ∈{I,A}⇔σⱼₗ∈{I,B}.

8. A computer-implemented method of claim 7, wherein, if the proviso of claim 7 is not satisfied, a diagonalisation of the qubit i or j is performed by:
finding a Pauli string with a lowest weight;
conjugating a corresponding Pauli gadget with a single-qubit Clifford gate and entangling gates; and
commuting the Clifford gate through a rest of the Pauli gadgets until all Clifford gates are outside their adjacent Pauli gadgets.

9. A computer-implemented method of claim 4, wherein the method further comprises:
performing Clifford peephole optimisation by finding patterns of two-qubit Clifford circuits; and
replacing the found patterns of two-qubit Clifford circuits with equivalent circuits having lower counts of entangling gates.

10. A computer-implemented method of claim 1, wherein the method includes transforming the phase gadgets into one- and two-qubit native gates to generate the quantum circuit using a phase polynomial formalism.

11. A computer-implemented method of claim 10, wherein the method includes transforming the phase gadgets by using the phase polynomial formalism, wherein phase polynomial formalism includes using a GraySynth procedure.

12. A computer-implemented method of generating a quantum circuit from a Hamiltonian using a parameterised operator including excitation operators to represent an excitation of a reference state, wherein the method includes determining multi-qubit Pauli operators from each excitation operator, wherein the method comprises:
partitioning the Pauli operators into mutually commuting sets and sequencing the Pauli operators by set;
generating Pauli gadgets from the Pauli operators by Trotterization, wherein the Pauli gadgets have the same sequencing by set as the Pauli operators;
diagonalising each set of Pauli gadgets to convert the Pauli gadgets into phase gadgets; and
transforming the phase gadgets into one- and two-qubit native gates to generate the quantum circuit;
wherein the Hamiltonian corresponds to a molecular structure.

13. A computer-implemented method of claim 12, wherein the multi-qubit Pauli operators are implemented as Pauli strings.

14. A computer-implemented method of claim 12, wherein the Hamiltonian corresponds to a Quantum Approximate Optimization Algorithm.

15. A computer-implemented method of claim 12, wherein the method is used to reduce a count and depth of entangling gates of the quantum circuit relative to a naïve synthesis of the quantum circuit from the Pauli operators.

16. (canceled)

17. A computer-implemented method of claim 12, further comprising using the quantum circuit to perform machine computations relating to at least one of the following: system optimization, variational inference, signal filtering, genetic data processing to find phenotypes and associated single nucleotide polymorphisms (SNP's), solid state physics, condensed matter physics, nuclear and/or particle physics, artificial intelligence, neural networks, and/or quantum systems having a Hamiltonian which is subject to Trotterization, such as for determining molecular structure or quantum evolution.

18. A non-transitory, computer-readable medium in which is stored a computer program that is executable on computing hardware for implementing a method to generate a quantum circuit from a Unitary Coupled Cluster (UCC) Ansatz, wherein the Ansatz represents an excitation of a reference state by a parameterised operator including excitation operators, wherein the Ansatz includes multi-qubit Pauli operators that are determined from each excitation operator, and wherein the program code is executable to implement a method comprising:
partitioning the Pauli operators into mutually commuting sets and sequencing the Pauli operators by set;
generating Pauli gadgets from the Pauli operators by Trotterization, wherein the Pauli gadgets have a same sequencing by set as the Pauli operators;
diagonalising each set of Pauli gadgets to convert the Pauli gadgets into phase gadgets; and
transforming the phase gadgets into one- and two-qubit native gates to generate the quantum circuit;
wherein the UCC Ansatz corresponds to a molecular structure.

19. A system for generating a quantum circuit from a Unitary Coupled Cluster (UCC) Ansatz, wherein the Ansatz represents an excitation of a reference state by a parameterised operator including excitation operators, wherein the Ansatz includes multi-qubit Pauli operators that are determined from each excitation operator, and wherein the system comprises:
a partitioning arrangement that is configured to partition the Pauli operators into mutually commuting sets and sequencing the Pauli operators by set;
a generating arrangement that is configured to generate Pauli gadgets from the Pauli operators by Trotterization, wherein the Pauli gadgets have a same sequencing by set as the Pauli operators;
a diagonalizing arrangement that is configured to diagonalise each set of Pauli gadgets to convert the Pauli gadgets into phase gadgets; and
a transforming arrangement that is configured to transform the phase gadgets into one- and two-qubit native gates to generate the quantum circuit;
wherein the UCC Ansatz corresponds to a molecular structure.

20. A system for generating a quantum circuit from a Hamiltonian using a parameterised operator including excitation operators to represent an excitation of a reference state, wherein the system is configured to determine multi-qubit Pauli operators from each excitation operator, wherein the system comprises:
a partitioning arrangement that is configured to partition the Pauli operators into mutually commuting sets and sequencing the Pauli operators by set;
a generating arrangement that is configured to generate Pauli gadgets from the Pauli operators by Trotterization, wherein the Pauli gadgets have the same sequencing by set as the Pauli operators;
a diagonalizing arrangement that is configured to diagonalise each set of Pauli gadgets to convert the Pauli gadgets into phase gadgets; and
a transforming arrangement that is configured to transform the phase gadgets into one- and two-qubit native gates to generate the quantum circuit;
wherein the Hamiltonian corresponds to a molecular structure.

21. A system of claim 20, wherein at least one of the partitioning arrangement, the generating arrangement, the diagonalization arrangement and the transforming arrangement is implemented using a compiler that is executable on at least one data processor.

22. A system of claim 19, wherein at least one of the partitioning arrangement, the generating arrangement, the diagonalization arrangement and the transforming arrangement is implemented using a compiler that is executable on at least one data processor.
